(19) United States
(12) Patent Application Publication
(10) Pub. No.: US 2026/0042342 A1
(43) Pub. Date: Feb. 12, 2026

(54) PARALLEL HYBRID SYSTEM WITH ELECTRIC MOTOR FOR VEHICLE

(71) Applicant: Hydro-Gear Limited Partnership, Sullivan, IL (US)

(72) Inventors: Thomas J. Langenfeld, Sullivan, IL (US); Nathan W. Bonny, Shelbyville, IL (US)

(21) Appl. No.: 19/361,880

(22) Filed: Oct. 17, 2025

Related U.S. Application Data
(63) Continuation-in-part of application No. 18/979,314, filed on Dec. 12, 2024.
(60) Provisional application No. 63/609,244, filed on Dec. 12, 2023.
(60) Provisional application No. 63/553,008, filed on Feb. 13, 2024.
(60) Provisional application No. 63/683,538, filed on Aug. 15, 2024.
(60) Provisional application No. 63/722,447, filed on Nov. 19, 2024.

(51) Int. Cl. B60K 6/383; A01D 34/64; A01D 34/78; A01D 69/02; A01D 69/08; A01D 101/00; B60K 6/48; B60K 6/50; B60K 17/28; F16D 41/12; F16D 43/16

(52) U.S. Cl. CPC B60K 6/383; A01D 69/025; B60K 6/48; B60K 6/50; B60K 17/28; F16D 41/12; F16D 43/16; A01D 34/64; A01D 34/78; A01D 69/08; A01D 2101/00; B60Y 2200/22; B60Y 2200/92; B60Y 2400/427

(57) ABSTRACT

A hybrid system for use with utility vehicles includes an electric motor including an output shaft and a conductor configured to alternatively receive power from or send power to an electrical power source. The hybrid system includes an internal combustion engine, a first pulley connected to and rotated by the internal combustion engine, and a clutch mechanism. The clutch mechanism includes a ratchet connected to the output shaft of the electric motor to rotate at a first rotational speed, a pawl carrier driven by the internal combustion engine to rotate at a second rotational speed, and one or pawls coupled to and configured to rotate with the pawl carrier. The one or more pawls are configured to be disengaged from the ratchet when the first and second rotational speeds differ and engaged with the ratchet when the first and second rotational speeds are equal.

### CROSS-REFERENCE

This application is a continuation-in-part of U.S. Non-Provisional Application No. Ser. No. 18/979,314, filed on Dec. 12, 2024, which claims priority to U.S. Provisional Ser. No. 63/722,447 , filed on Nov. 19, 2024; U.S. Provisional Ser. No. 63/683,538, filed on Aug. 15, 2024; U.S. Provisional Ser. No. 63/553,008 , filed on Feb. 13, 2024; and U.S. Provisional Ser. No. 63/609,244 , filed on Dec. 12, 2023. These prior applications are incorporated by reference herein in their entirety.

### TECHNICAL FIELD

This application relates to a parallel hybrid power and control system for auxiliary motors of a utility vehicle. The system may be used with electric deck motor assemblies for a zero turn-radius (ZT) lawn mower or other applications.

### BACKGROUND

Utility vehicles and/or their auxiliary implements may be powered by a traditional prime mover (e.g., an internal combustion engine or other combustion power source), may be purely electric, or may use some combination of a traditional engine and electric battery source, i.e., a “hybrid” system. Electric systems have the benefit of producing no emissions. Hybrid systems developed in large part due to concerns over perceived limited range/operating time of purely electric systems.

Hybrid systems may be series or parallel. A series hybrid system includes an engine, a generator powered by the engine, and one or more electric motors powered by the generator. This allows for constant and continuous power delivery, but is inefficient due to losses as energy is converted from mechanical to electrical and back again.

A parallel hybrid system uses an engine, a battery (or battery pack) to provide power to electric motor(s), and a power split device connecting the motor(s) and engine to the drive wheels. Either the electric motor or the engine or both can power the vehicle. When the battery power is low, the electric motor can be powered by the engine to charge the battery. Such a system can be efficient, but requires careful management of the engagement/disengagement of the engine to avoid depleting the battery. What is needed is application of an efficient parallel hybrid system to a utility vehicle equipped with auxiliary implements such as cutting blades on a lawn mower.

### SUMMARY

A mowing vehicle having a parallel hybrid power and control system and utilizing one or more electric mowing deck motors, each having a pulley and a one-way clutch bearing, is disclosed herein. The deck motors can be driven electrically or by an engine-driven belt to enable utilization of the parallel hybrid power and control system.

A second embodiment of a mowing vehicle having a parallel hybrid power and control system and utilizing one or more electric mowing deck motors, each having a pulley and an electric clutch, is also disclosed herein. As in the first embodiment, the deck motors can be powered electrically or driven mechanically by an engine-driven belt to enable utilization of the parallel hybrid power and control system.

A third embodiment of a mowing vehicle having a parallel hybrid power and control system utilizing a single electric mowing deck motor having a pulley system and an electric clutch is also disclosed herein. In this embodiment, the single electric deck motor and one or more conventional deck spindles are belt-driven as a group. The deck motor can be powered electrically or driven mechanically by an engine-driven belt to enable utilization of the parallel hybrid power and control system.

A fourth embodiment of a mowing vehicle having a parallel hybrid power and control system utilizing one or more electric mowing deck motors, each having an input pulley but not having a clutch or one-way clutch bearing, is also disclosed herein. In this embodiment, the one or more electric deck motors (and one or more optional deck spindles) are belt-driven as a group. As in the other embodiments, the deck motor(s) can be powered electrically or driven mechanically by an engine-driven belt to enable utilization of the parallel hybrid power and control system. The mowing vehicle in this embodiment includes an internal combustion engine with a conventional electromagnetic power take-off clutch mounted on its output shaft to drive the electric mowing deck motors mechanically.

Each of the electric deck motor assemblies may be a mid-mount deck motor assembly and may be configured with or without a Hall effect board. In the embodiments of the electric motor assemblies disclosed herein, motor mounting features are integrally formed on an upper housing and positioned such that, when the motor is mounted on a mowing deck, a substantial portion of the electric motor is situated below the mowing deck and exposed to cooling air flow generated by the rotation of mower blades of the mowing deck during operation. The mounting surfaces have threaded holes formed therein so the deck motors can be seated on top of the mowing deck but fastened from the underside of the deck along with the mower blades for a more efficient assembly process (i.e. allowing a mower manufacturer to fasten blades and deck motors to the deck at one assembly station without flipping the deck over at that assembly station).

The electric deck motors described herein may also be referred to more generally as “power take-off motors” or “PTO motors.” While the disclosures herein relate to a mowing vehicle, a person of ordinary skill in the art will appreciate that the parallel hybrid power and control systems described herein could be implemented with other utility vehicles that perform other auxiliary functions different than rotating a mowing blade. For example, instead of a mower the machine may be for snow removal and the PTO motor may power an auger to gather and expel snow. The machine may be a utility vehicle and the PTO motor(s) may power various auxiliary implements such as a mixer, a broom for street cleaning, or other auxiliary implements that can be driven via an output shaft. In such other applications, it will be understood that the “mowing deck” referred to herein would be more broadly referred to as a “mounting deck.” Accordingly, the terms “mounting deck”and “mowing deck”are used synonymously herein.

A better understanding of the disclosure herein will be obtained from the following detailed description and accompanying drawings.

### BRIEF DESCRIPTION OF THE DRAWINGS

FIG. 1 is a schematic view of a first embodiment of a representative vehicle including a mowing deck and utilizing the parallel hybrid system of the instant disclosure.

FIG. 2 is a top plan view of a first embodiment of an electric deck motor assembly that may be used on the mowing deck of the vehicle of FIG. 1 to drive mower blades.

FIG. 3 is an elevational view of the electric deck motor assembly of FIG. 2.

FIG. 4 is a top plan view of a pulley assembly with a one-way clutch bearing mounted on the motor output shaft of the electric deck motor assembly of FIG. 2, with a pulley retaining washer and fastener removed for clarity.

FIG. 5 is an elevational view of the pulley assembly and motor output shaft of FIG. 4, with shaft seal, upper bearing and lower sealed bearing.

FIG. 6 is a perspective view of the underside of the pulley assembly of FIG. 5.

FIG. 7 is an exploded perspective view of the pulley assembly of FIG. 6.

FIG. 8 is an exploded perspective view of a pulley hub and bearing adapter of the pulley assembly of FIG. 7, rotated 180 degrees about the rotational axis of the motor output shaft, as compared to FIG. 7.

FIG. 9 is a schematic view of a second embodiment of a representative vehicle including a mowing deck and utilizing the parallel hybrid system of the instant disclosure.

FIG. 9A is an elevational view of an electric deck motor assembly with an electric clutch that may be used on the mowing deck of the vehicle of FIG. 9 to drive mower blades.

FIG. 10 is a schematic view of a third embodiment of a representative vehicle including a mowing deck and utilizing the parallel hybrid system of the instant disclosure.

FIG. 10A is an elevational view of an electric deck motor assembly with an electric clutch and two pulleys, which may be used on the mowing deck of the vehicle of FIG. 10 to drive mower blades.

FIG. 11 is a schematic view of a fourth embodiment of a representative vehicle including a mowing deck and utilizing the parallel hybrid system of the instant disclosure.

FIG. 12 is a perspective view of a second embodiment of an electric deck motor assembly that may be used on the mowing deck of the vehicle of FIG. 1 to drive mower blades.

FIG. 13 is a top plan view of the electric deck motor assembly of FIG. 12.

FIG. 14 is a cross-sectional view of the electric deck motor assembly of FIG. 13, along the line 14-14 in FIG. 13.

FIG. 15 is a perspective view of the underside of the pulley assembly of the electric deck motor assembly of FIG. 12 with the motor output shaft connected.

FIG. 16 is an exploded perspective view of the pulley assembly of FIG. 15.

FIG. 17 is a top plan view of a third embodiment of an electric deck motor assembly with pulley assembly that may be used on the mowing deck of the vehicle of FIG. 1 to drive mower blades.

FIG. 18 is a cross-sectional view of the pulley assembly of the electric deck motor assembly of FIG. 17, along the line 18-18 in FIG. 17.

FIG. 19 is a partially exploded perspective view of the pulley assembly of the electric deck motor assembly of FIG. 17.

FIG. 20 is a perspective view of the lower side of the ratchet and pawls clutch mechanism of the pulley assembly of the electric deck motor assembly of FIG. 17, depicted in a disengaged state.

FIG. 21 is a perspective view of the upper side of the ratchet and pawls clutch mechanism of the pulley assembly of the electric deck motor assembly of FIG. 17, depicted in a disengaged state.

FIG. 22 is a perspective view of the upper side of the ratchet and pawls clutch mechanism of the pulley assembly of the electric deck motor assembly of FIG. 17, depicted in an engaged state.

FIG. 23 is a plan view of the upper side of the ratchet and pawls clutch mechanism of the pulley assembly of the electric deck motor assembly of FIG. 17, depicted in a disengaged state.

FIG. 24 is a top plan view of a fourth embodiment of an electric deck motor assembly with pulley assembly that may be used on the mowing deck of the vehicle of FIG. 1 to drive mower blades.

FIG. 25 is a cross-sectional view of the pulley assembly of the electric deck motor assembly of FIG. 24, along the line 25-25 in FIG. 24.

FIG. 26 is a partially exploded perspective view of the pulley assembly of the electric deck motor assembly of FIG. 24.

FIG. 27 is a partially exploded perspective view of the hub assembly of the pulley assembly of FIG. 26, with the ratchet and pawls clutch mechanism depicted in an engaged state.

FIG. 28 is a partially exploded perspective view of the ratchet and pawls clutch mechanism with lower housing of the hub assembly of FIG. 27, with the ratchet and pawls clutch mechanism depicted in an engaged state.

FIG. 29 is a partially exploded perspective view of the opposite side of the ratchet and pawls clutch mechanism with upper housing of the hub assembly of FIG. 27, with the ratchet and pawls clutch mechanism depicted in an engaged state.

FIG. 30 is a plan view of the upper side of the ratchet and pawls clutch mechanism of the pulley assembly of the electric deck motor assembly of FIG. 24, depicted in a disengaged state.

FIG. 31 is a plan view of the upper side of the ratchet and pawls clutch mechanism of the pulley assembly of the electric deck motor assembly of FIG. 24, depicted in an engaged state.

### DETAILED DESCRIPTION OF THE DRAWINGS

The description that follows describes, illustrates and exemplifies one or more embodiments in accordance with its principles. This description is not provided to limit the disclosure to the embodiment(s) described herein, but rather to explain and teach the principles of the invention(s) disclosed herein to enable one of ordinary skill in the art to understand these principles and, with that understanding, be able to apply them to practice not only the embodiment(s) described herein, but also any other embodiment that may come to mind in accordance with these principles. The scope of the disclosure is intended to cover all such embodiments that may fall within the scope of the appended claims, either literally or under the doctrine of equivalents.

It should be noted that the drawings set forth herein are not necessarily drawn to scale and, in some instances, proportions may have been exaggerated to depict certain features more clearly. Positional references such as “upper” and “lower” may be used in regard to certain components to aid in understanding but are not to be construed as limiting since these components and the drive units in which they are housed may be oriented in various ways depending on the application in which they are used. As stated above, this specification is intended to be taken as a whole and interpreted in accordance with the principles of the invention(s) as taught herein and understood by one of ordinary skill in the art.

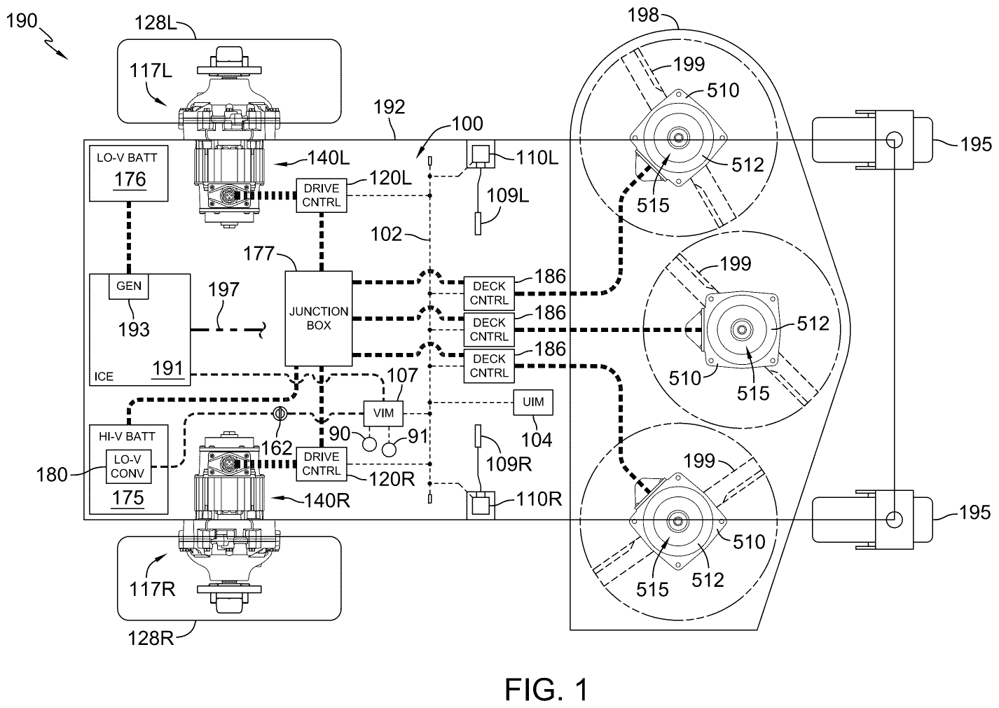

FIG. 1 depicts a parallel hybrid, zero turn-radius mowing vehicle 190 that incorporates one or more electric deck motors 510 (three deck motors shown) that may be powered electrically or driven by an engine-driven belt 197. A second embodiment of an electric deck motor assembly 810 subsequently described herein may be substituted for deck motor assembly 510 in any vehicle embodiment or operational mode utilizing one or more deck motor assemblies 510. In each of the embodiments disclosed herein, belt 197 may be a belt system or belt and pulley system, may comprise more than one belt, and may include additional belt-drive components, such as belt tensioners, etc., as needed. Various belt and pulley systems are known in the art and will not be described in detail herein. An electric mid-mount deck motor, similar to those depicted herein, (but without an input pulley, clutch or one-way clutch bearing) is illustrated and described in more detail in commonly-owned U.S. patent application Ser. No. 18/900,385, the terms of which are incorporated herein by reference. It should be noted that electric motor configurations other than the “mid-mount” configurations illustrated herein may be used with the input pulley assemblies and one-way clutch configurations disclosed herein.

Hybrid mowing vehicle 190 includes a vehicle frame 192; an internal combustion (IC) engine 191 with a generator or alternator 193 to maintain charge (e.g., 12V) of a low voltage battery 176; a mowing deck 198 comprising belt-drive components (not shown) to drive deck motors 510 as a group when powered by the IC engine 191 via belt 197; a pair of caster wheels 195; a CAN (controller area network) bus 102; left and right operator controls such as lap bars 109L, 109R comprising left and right lap bar sensor modules 110L, 110R connected to the CAN bus; a vehicle integration module (VIM) 107; and a high voltage battery or battery pack 175 (e.g., 48V, 58V, 88V, etc.) that can be connected to an external battery charging unit or charging station (not shown). Vehicle 190 also includes left and right electrically powered reduction drive units 117L, 117R that include electric drive motors 140L, 140R, respectively, that are connected to and controlled by left and right traction drive controllers 120L, 120R. The reduction drive units 117L, 117R (a.k.a. “traction drives” or “traction drive units”) separately drive left and right driven wheels 128L, 128R. Mowing deck 198 may feature one or more mower blades 199. Each mower blade 199 is powered by an electric deck motor 510 that is electrically connected to and independently controlled by a dedicated deck motor controller 186. It should be noted that deck motor controllers 186 may be housed individually or as a group within a single deck motor controller housing or protective structure. Deck motor controllers 186 and drive motor controllers 120L, 120R are all connected to CAN bus 102 and receive high voltage DC power via junction box 177 connected to high voltage battery pack 175. Deck motor controllers 186 and drive motor controllers 120L, 120R convert incoming DC power to provide three-phase power output to the deck motors 510 and the electric drive motors 140L, 140R of reduction drive units 117L, 117R.

High voltage battery pack 175 includes a low voltage converter 180 (e.g., 12V). A vehicle power key switch 162 is electrically interposed between low voltage converter 180 and VIM 107. The VIM 107 is connected to CAN Bus 102 and a deck power switch 90 (a.k.a. “power take-off” or “PTO” switch) is connected to VIM 107 to enable and disable operation of the electric deck motors 510 via deck motor controllers 186.

An operational mode or power mode switch 91 for switching between two or more vehicle operational modes may also be connected to VIM 107. Optionally, or in addition to power mode switch 91, a user interface module 104 (e.g., an interface module including a touch-screen display) connected to the CAN bus 102 may be used to switch between or among the two or more vehicle operational modes.

Operational modes of vehicle 190 (and other vehicle embodiments described herein) may include, among other possible modes, a Hybrid (Standard Operation) Mode, an EV Mode, and a Power Mode, as described below. Each mode will have an associated Min SOC (Minimum State of Charge) and Max SOC (Maximum State of Charge). These limits are set at levels designed to reduce stress on the batteries and extend battery life. They may be configurable in relation to the desired run-time parameters of a particular application.

Hybrid (Standard Operation) Mode: In this mode, which is typically the default or standard mode, hybrid mowing vehicle 190 will operate solely under electric power when the high voltage battery SOC is greater than the minimum set SOC (for example, 30%). During this time, the traction drives 117L, 117R and deck motors 510 will be driven solely by electric power. When the SOC of high voltage battery 175 drops below the Min SOC setpoint (e.g., 30%), engagement of the PTO switch 90 will cause the VIM 107 to command the IC engine 191 to start. VIM 107 will send this command automatically if the PTO switch 90 is already engaged when the SOC drops below the Min SOC setpoint. Alternatively, VIM 107 may command the IC engine 191 to start and run based on various vehicle sensor inputs, such as ambient temperature or battery SOC levels, and engine run configuration parameters.

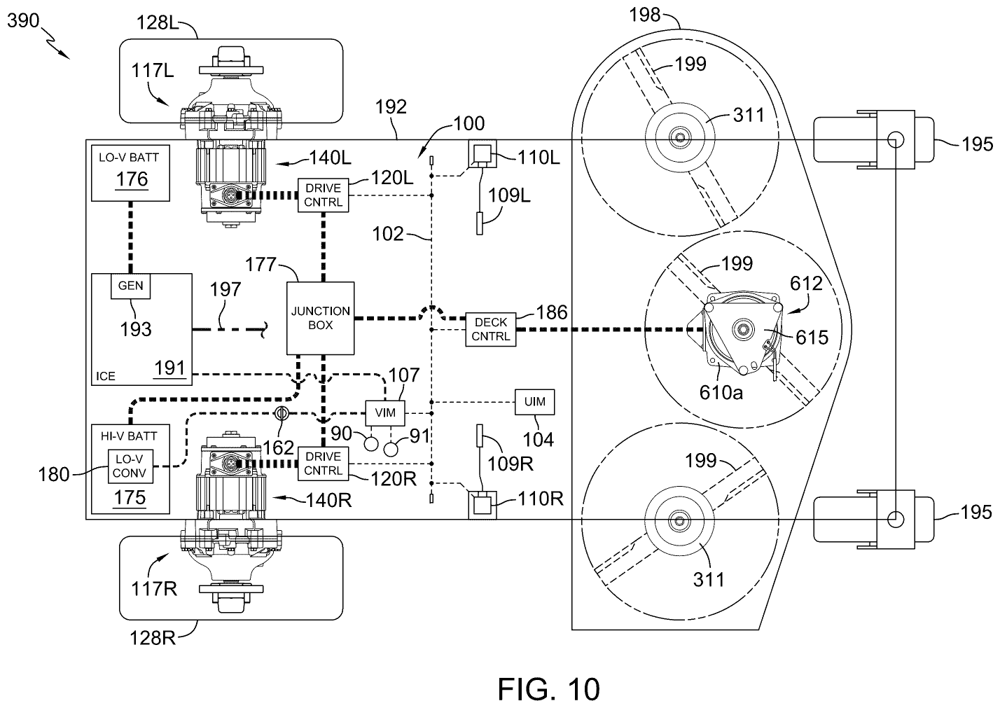

IC engine 191 directly drives the belt 197 configured to drive the one or more deck motors 510 via belt power through an input pulley assembly 512 with an attached one-way clutch bearing 515 (also known as a “sprag clutch” or “sprag clutch bearing”). In a second embodiment of a hybrid mowing vehicle 290, each electric deck motor 610 is driven through an input pulley assembly 612 including an electric clutch 615. IC engine 191 is configured to run only when the PTO switch 90 is engaged and PTO safety and operational parameters are met. IC engine 191 receives load from deck motors 510 when engine-driven input speed of deck motors 510 reaches the electrically-driven input speed of deck motors 510 or when the VIM 107 switches the power mode of electric deck motor controllers 186 from “motoring” to “generating.” In the second embodiment vehicle 290 (see FIG. 9), IC engine 191 receives load from deck motors 610 when IC engine 191 reaches a set target speed monitored by VIM 107, and VIM 107 commands one or more electric clutches 615 to engage. VIM 107 may then switch the power mode of deck motor controllers 186 from “motoring” to “generating” [and vice versa], as programmed. In some vehicle embodiments, electric clutches 615 may also be selectively engaged or disengaged [individually or as a group] by the vehicle operator or in response to sensor or camera communication with the VIM 107.

In “generating mode,” the VIM 107 will monitor RPM output of the IC engine 191 and, once VIM 107 verifies engine 191 is at full speed, VIM 107 will command the deck motors 510 connected to the engine-driven belt 197 to begin generating power back to the high voltage battery 175. The power generation to battery 175 will be increased to the peak output unless the deck motor controllers 186 sense a reduction in RPM of the deck motors 510. If deck motor RPM decreases, the deck motor controllers 186 will reduce generation load (i.e., the load directed toward recharging the high voltage battery 175), and thereby allow more IC engine power to drive the mower blades 199. If deck motor RPM continues to decrease, the deck motor controllers 186 can shift deck motors 510 to “motoring mode” where they temporarily draw power from the high voltage battery 175 to increase the available electric deck motor power above that supplied by the IC engine 191 (see also “Power Mode” below). Once the generation of power recharges the high voltage battery to the Max SOC (for example, 80%), the vehicle will return to operating under fully electric power until the battery SOC returns to Min SOC and the re-charge cycle starts again.

EV Mode: In this mode of operation, the Min SOC of high voltage battery 175 would be reduced (to 10%, for example) to extend the electric-only run time. When the battery reaches Min SOC, the deck motors 510 will shut down to preserve battery power for transportation, and vehicle 190 can either be switched to Hybrid Mode to recharge the high voltage battery 175 or taken to a recharge station.

Power Mode: The selection of Power Mode may be useful in times of extreme operation wherein the IC engine 191 and electric deck motors 510 cooperate to keep the motor output shaft 525 rotating at a target RPM. This mode will start the IC engine 191 if all safety conditions are acceptable and the PTO switch 90 is enabled. The IC engine 191 will run at all times in this mode when the PTO function is enabled. The deck motor controllers 186 will operate the deck motors 510 in either “generating mode” (charging high voltage battery 175) or “motoring mode” (pulling power from high voltage battery 175) depending on the load on the IC engine 191 and the SOC of the battery pack 175. The SOC for this mode may be set to a higher point (for example, 60%) up to a Max SOC setpoint (for example, 90%). In this mode, the IC engine 191 will continue running as long as the PTO switch 90 is enabled and the necessary conditions are met for vehicle operation.

In addition to SOC, during operation of the deck motors 510, VIM 107 monitors the consumed current from each system controller (e.g., deck motor controllers 186, left and right traction drive controllers 120L, 120R) and from high voltage battery 175. The parallel hybrid system has configurable operation time limits for any high current operations. In order to reduce the load during such operations, the system when in EV Mode, will reduce the vehicle speed at a configured deceleration rate until the load on the system drops to a configurable limit. Once the load is sufficiently reduced, the vehicle ramps speed back up in a controlled manner. When in Hybrid Mode during high current operations, instead of slowing the vehicle speed, the system will utilize the IC engine 191 to supplement the vehicle electrical power demand on high voltage battery 175. When the load from mowing (or other auxiliary) operations reduces, VIM 107 will shut down ICE 191 and ready it for restarting when necessary based on load or battery SOC.

It will be understood that vehicles 190 and 290 (as well as vehicles 390 and 490 discussed below) may include other steering and drive input systems, such as a steering wheel and accelerator pedal, joystick, remote control, etc. The above-described parallel hybrid drive and control system could be used on a vehicle having steerable front wheels connected to a rack-and-pinion steering mechanism and/or a vehicle having a single motor driving both rear wheels. It will also be understood that the parallel hybrid drive and control system 100 illustrated in FIG. 1 comprises the electrical components and functions shown and may comprise additional electrical components and functions not shown (e.g., sensors, cameras, GPS receiver, Bluetooth module, inertial measurement unit, path controller, battery management system, remote control transceiver, safety interlock switches, etc.). Drive and control system 100 and related components of vehicle 190 shown herein can also be used in an autonomous vehicle.

It will further be understood that the electric deck motors 510, 610, 610a, 710, 810, 910, 1010 disclosed herein may be used in other vehicle applications (e.g., without a CAN bus 102; with a vehicle controller in lieu of VIM 107; with a power take-off function other than mowing; in a vehicle having a single electric transaxle and a single drive controller).

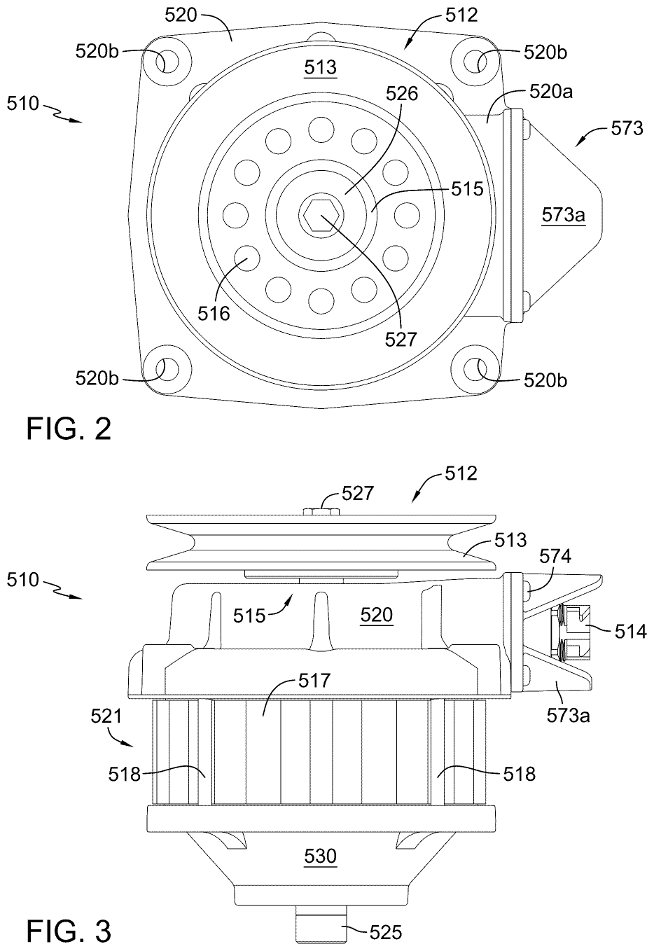

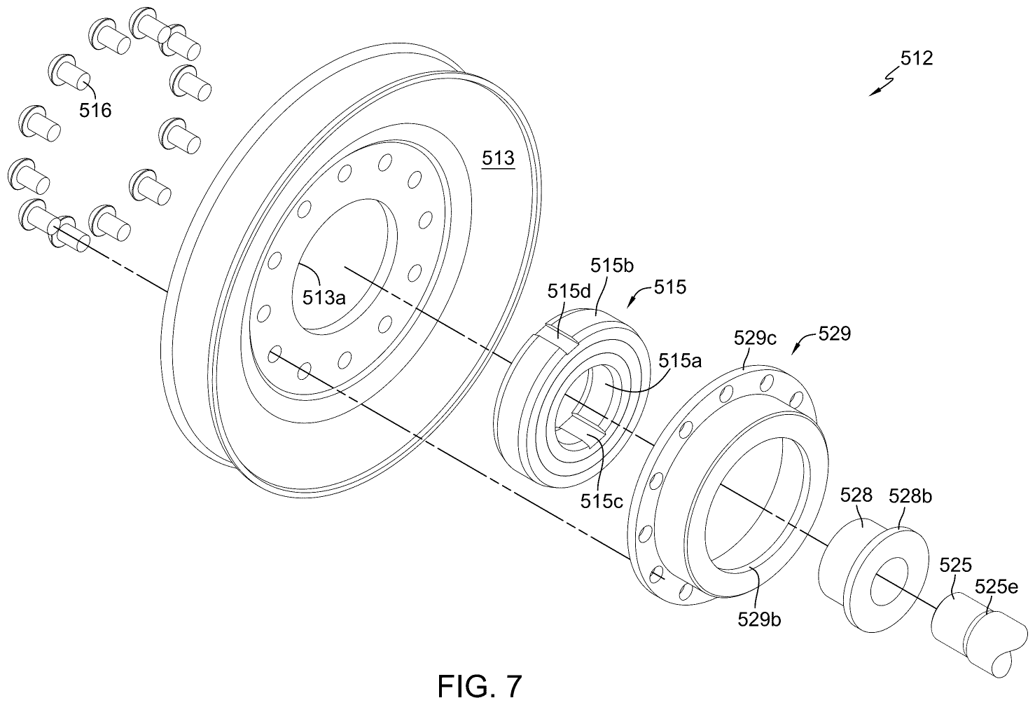

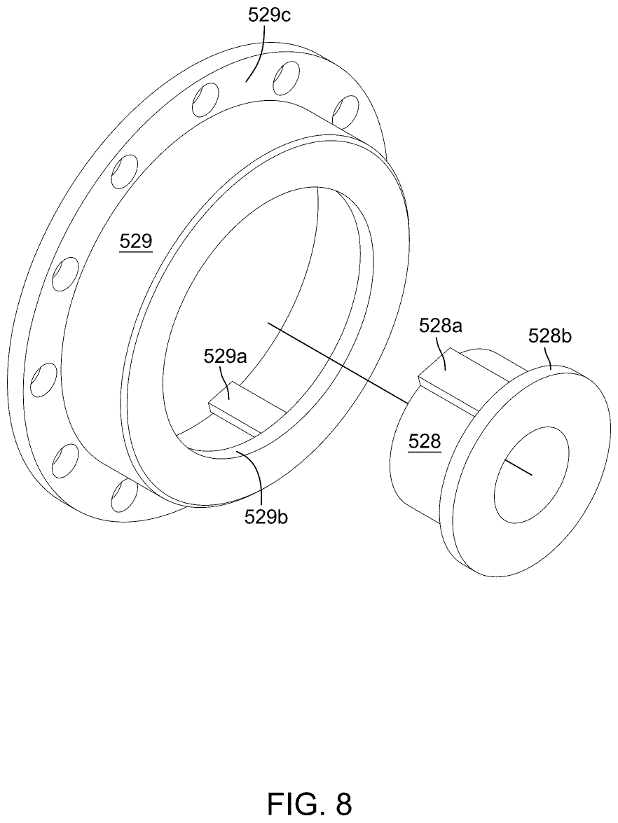

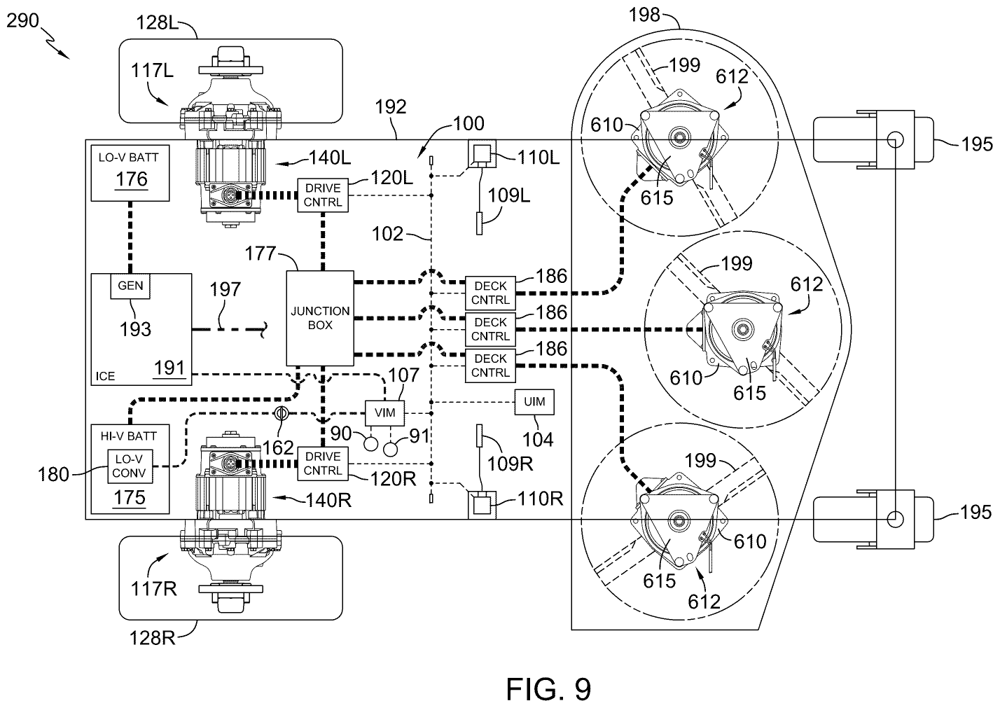

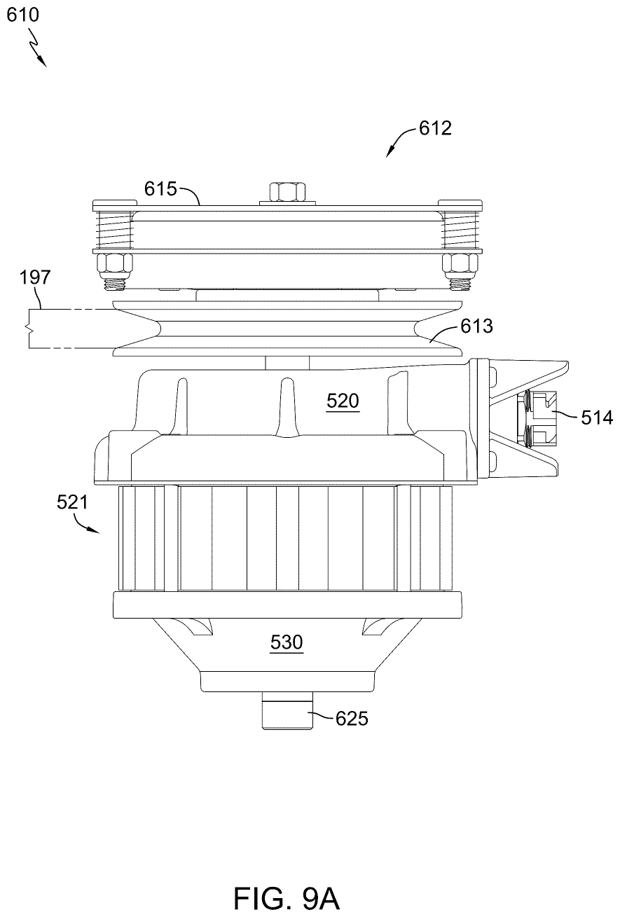

An electric motor assembly 510 suitable for mounting on the mowing deck 198 of mowing vehicle 190, and enabling the functionality of the parallel hybrid system disclosed herein, is shown in FIGS. 2-8. Motor assembly 510 includes an input pulley assembly 512 comprising pulley 513 and a sealed, one-way clutch bearing 515. The input pulley assembly 512 is mounted on the upper end of electric motor output shaft 525 (see FIG. 5) and retained by a retaining washer 526 and threaded fastener 527 (see FIG. 2). Threaded fastener 527 passes through a central hole 513a in pulley 513 (see FIG. 7) to engage an upper threaded bore 525a of output shaft 525. Retaining washer 526 seats against the inner race 515a of one-way clutch bearing 515, such that motor output shaft 525 rotates with inner race 515a. As described more fully below, the one-way clutch 515 is captured within pulley hub 529, which is, in turn, riveted to the pulley 513, such that the pulley 513 rotates with the outer race 515b.

As illustrated, a motor output cap 530 (lower housing) is joined to a motor end cap 520 (upper housing) via fasteners 518, with a motor stator housing 517 (middle housing) interposed between motor output cap 530 and motor end cap 520 to form an electric motor compartment containing electric motor 521. As shown in FIG. 2, motor end cap 520 includes threaded mounting holes 520b to attach electric deck motor 510 to mowing deck 198 of vehicle 190. In the exemplary embodiment, motor stator housing 517 is a finned aluminum extrusion cut to a length dependent upon the number of laminations used to form the motor stator (not shown). The fins improve heat dissipation and provide stiffness but may not be required in some similar embodiments. Electric motor 521 comprises a motor stator, motor windings, and a motor rotor assembly that includes a motor rotor and magnets (electric motor components not shown). At the lower end of motor output shaft 525, for attachment of a mower blade 199, adapter mounting features such as lower threaded bore 525c and flats 525d are provided for securing a blade adapter by means of a mechanical fastener and mating flats formed on the blade adapter. Another common blade adapter interface that can be used in lieu of flats 525d is a keyway interface (not shown) that may allow shearing of a “key” in the event a mower blade strikes a solid object. A keyway interface may help prevent or reduce damage to electric deck motor assembly 510 in such an event.

Electric motor output shaft 525 extends through electric motor 521, motor end cap 520 and motor output cap 530. Electric motor output shaft 525 is supported by an upper bearing 575 located in motor end cap 520 adjacent to shaft seal 577 and by a lower sealed bearing 576 located in motor output cap 530. Splines 525b formed on motor output shaft 525 permanently secure the motor rotor assembly (not shown) to the motor output shaft 525 via press-fit.

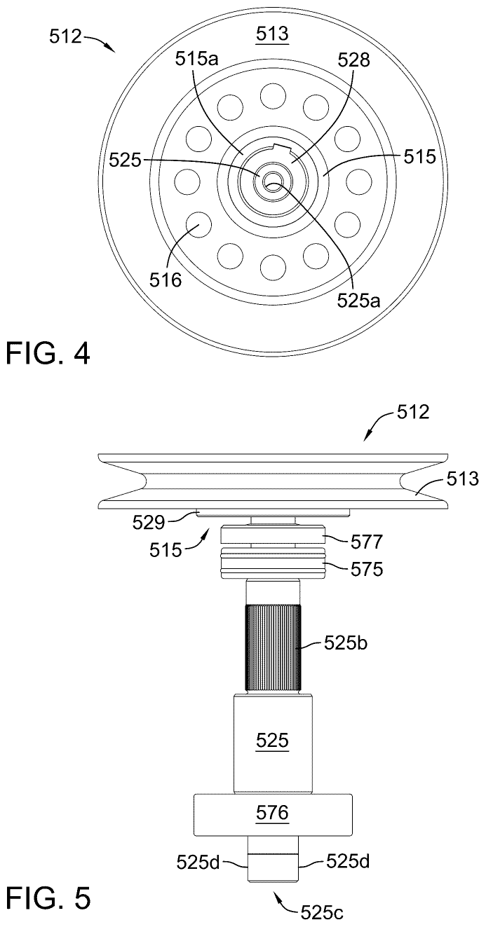

As shown in FIGS. 2 and 3, an environmentally sealed electrical connector 514 is attached or mounted to an electrical compartment cover 573. Compartment cover 573 includes connector guards 573a that extend beyond the sealed electrical connector 514 to protect it. Compartment cover 573 is secured by fasteners 574 to an electrical compartment 520a that may be integrally formed on the motor end cap 520.

As an option, a Hall effect board (not shown) may be attached to motor end cap 520 adjacent to the rotor assembly as illustrated and described in more detail in commonly-owned U.S. Pat. No. 11,211,844, which is incorporated by reference herein in its entirety. When configured with such a Hall effect board, electric motor assembly 510 can provide motor operational information (e.g., motor speed and temperature) to one or more electronic components of the vehicle control system.

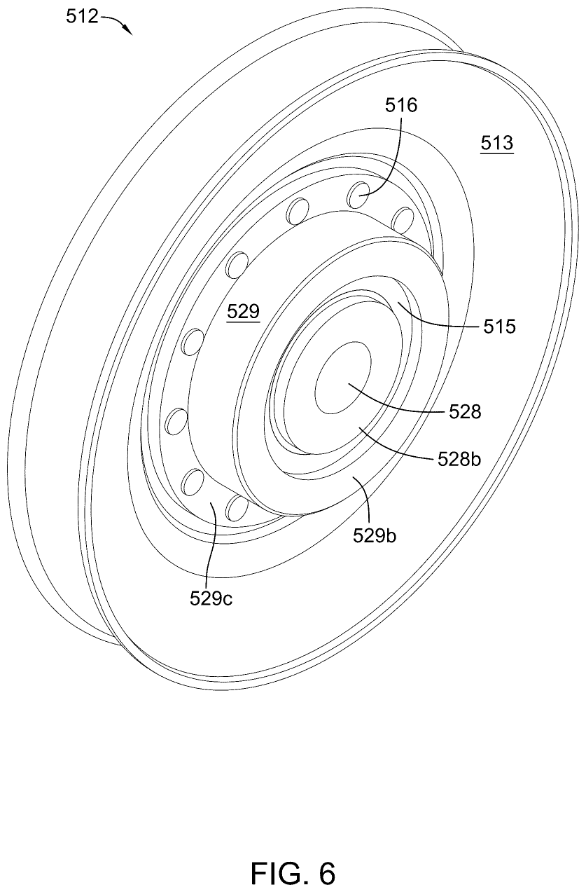

An exemplary embodiment of input pulley assembly 512 is depicted in FIGS. 4 and 6-8. Input pulley assembly 512 includes a pulley hub 529 that houses the one-way clutch bearing 515. Bearing 515 comprises a bearing inner race 515a with inner keyway 515c and a bearing outer race 515b with outer keyway 515d. A mounting flange 529c of pulley hub 529 is attached to pulley 513 by means of rivets 516 but could also be attached with other types of fasteners such as screws into threaded housings or bolts through unthreaded housings. A hub key 529a of pulley hub 529 engages the outer bearing race keyway 515d such that pulley 513 rotates with the bearing outer race 515b. An adapter key 528a of a bearing adapter 528 engages the inner bearing race keyway 515c such that the electric motor output shaft rotates with the bearing inner race 515a. To help retain the one-way clutch bearing 515 and pulley 513 on output shaft 525, bearing adapter 528 includes a bearing inner race retention flange 528b and pulley hub 529 includes a bearing outer race retention flange 529b. During assembly, bearing adapter 528 is slipped onto the upper end of the motor output shaft 525 and is seated against shoulder 525e formed on output shaft 525. Bearing adapter 528 is retained along with the other components of input pulley assembly 512 when retaining washer 526 and fastener 527 are installed through the central hole 513a in pulley 513 and into threaded bore 525a of motor output shaft 525.

The motor output shaft 525 rotates independently when driven by electric power only and rotates with pulley 513 when pulley 513 is driven at sufficient speed by the IC engine that the pulley's RPM (outer race 515b) reaches (and matches) that of the output shaft (inner race 515a), causing the clutch function of the one-way clutch bearing 515 to engage. This causes the inner race and outer race to rotate together such that the input pulley assembly 512 drives the motor output shaft 525. With rotational speeds of pulley 513 and motor output shaft 525 matched, the connector (or other conductor) sends power to the battery when the belt power to pulley 513 exceeds the load on the motor output shaft 525 (transferred from a deck motor blade 199, for example).

It should be noted that adapter key 528a may be integrally formed with bearing adapter 528, and hub key 529a may be integrally formed with pulley hub 529, as illustrated herein. Optionally, bearing adapter 528 and/or pulley hub 529 may comprise a keyway and have a separate key component, as is known in the art.

FIG. 9 depicts a second embodiment of a parallel hybrid, zero turn-radius mowing vehicle 290 similar to vehicle 190 in most respects, but incorporating one or more electric deck motors 610 (three shown) having electric clutches. Motor assembly 610 (see FIG. 9A) includes input pulley assembly 612 (comprising an electric clutch 615 and input pulley 613) mounted on the motor output shaft 625. Electric clutch 615 may be a conventional electric clutch, such as a “Mobile Clutch” available from Ogura Industrial Corporation, 100 Randolph Road, Somerset, New Jersey 08873, for example. When an electric clutch 615 is disengaged, the corresponding electric deck motor 610 is driven electrically. When the electric clutch 615 is engaged, the corresponding electric deck motor 610 is driven mechanically by IC engine 191, and may also continue to be driven electrically. VIM 107 may be configured to engage and disengage electric clutches 615 together or individually.

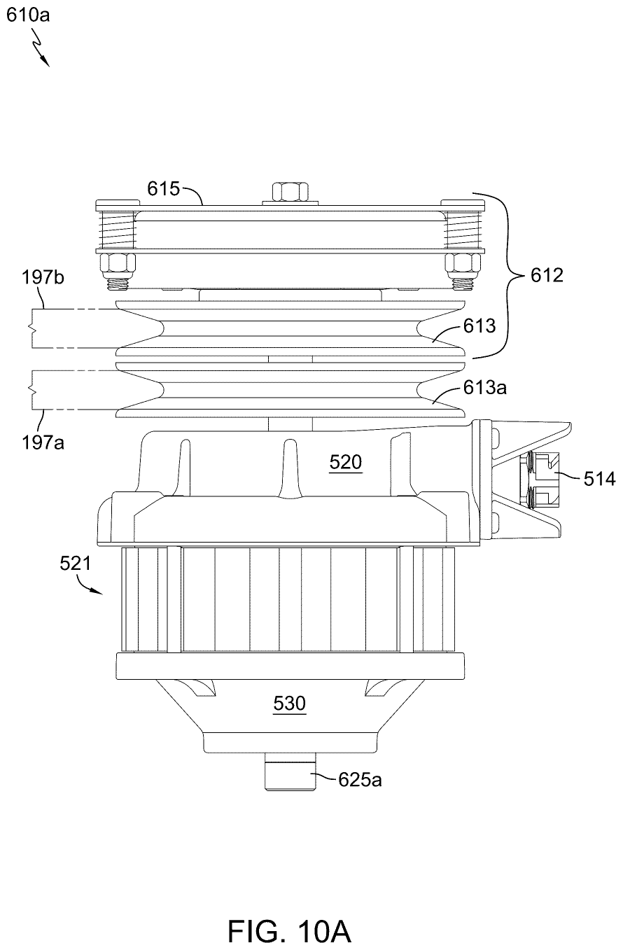

In a third embodiment of a parallel hybrid, zero turn-radius mowing vehicle 390 (see FIGS. 10 and 10A), a single electric deck motor assembly 610a (including input pulley assembly 612 and a second input pulley 613a) and one or more conventional deck spindles 311 (two shown) are driven by belt system 197. Input pulley 613a is fixed to the output shaft 625a of electric deck motor assembly 610a, and pulley 613 of input pulley assembly 612 is selectively engaged to the output shaft 625a via electric clutch 615. Belt system 197 comprises a first belt 197a connecting pulley 613a with the one or more conventional deck spindles 311 to enable electric powering of mowing deck 198. Belt system 197 further comprises a second belt 197b connecting IC engine 191 with pulley 613 to enable mechanical operation of mowing deck 198. As described above, IC engine 191 will run if all safety conditions are met. But in this embodiment, PTO switch 90 enables electric clutch 615 to mechanically power electric deck motor assembly 610a via IC engine 191. The operational modes of vehicle 390 may be the same as described above for vehicle 190 (with electric deck motor 510) or vehicle 290 (with electric deck motors 610).

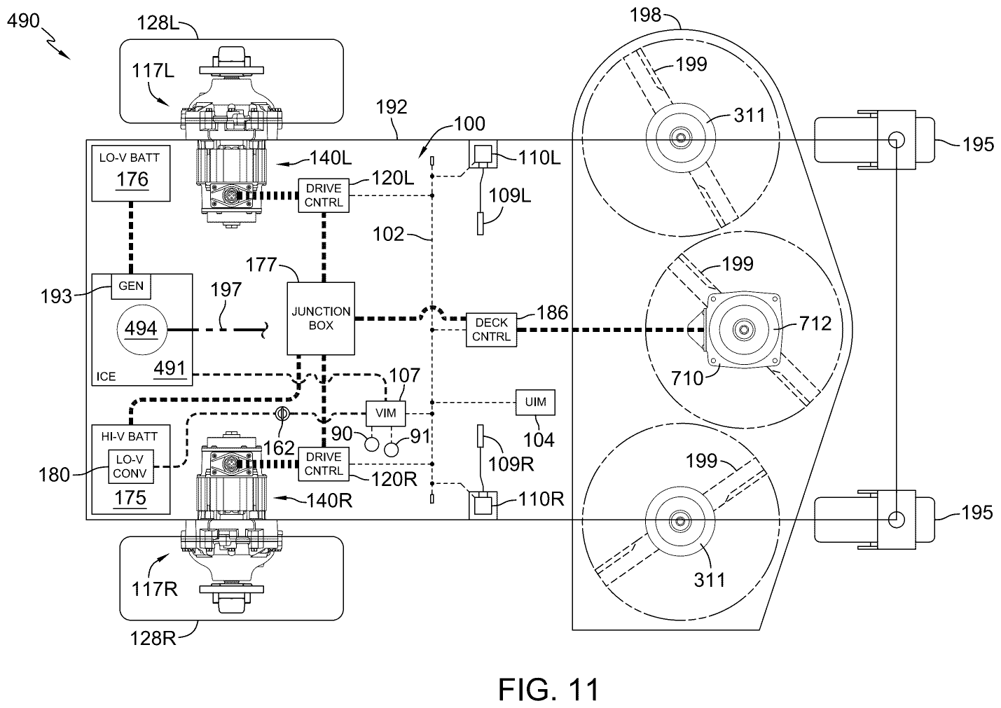

In a fourth embodiment of a parallel hybrid, zero turn-radius mowing vehicle 490 (see FIG. 11), a conventional PTO clutch 494 may be mounted on the output shaft of IC engine 191, as is known in the art. Such electromagnetic “General Purpose Clutches” are also available from Ogura Industrial Corporation, for example. One or more electric deck motors 710 may be driven by engine-driven belt 197 through an input pulley 712 mounted on each deck motor output shaft 525. Similar to the third embodiment, mowing deck 198 may be configured with a single electric deck motor 710 (as shown) in combination with one or more conventional deck spindles 311 (two shown). Optionally, and similar to the first and second embodiments, mowing deck 198 may include one or more electric deck motors 710 (each having a dedicated deck motor controller 186) and may include unpowered, belt-driven deck spindles such as conventional deck spindles 311 driven by belt 197. Operational modes of vehicle 490 may include modes similar to those described above, except deck motors 710 do not include a clutch or one-way clutch bearing and IC engine 491 may also be configured to run at times when the PTO switch 90 is not engaged.

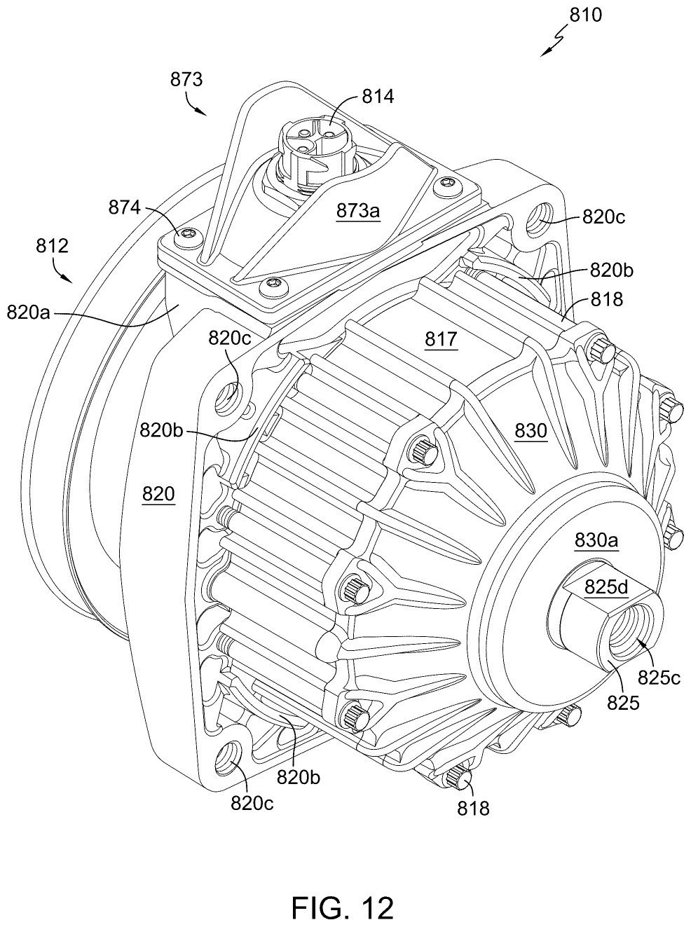

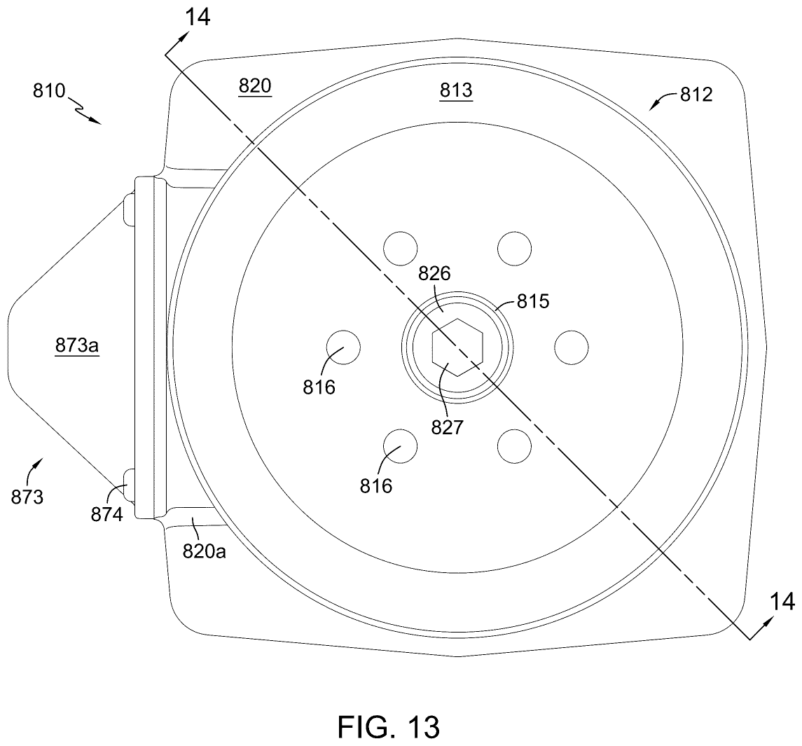

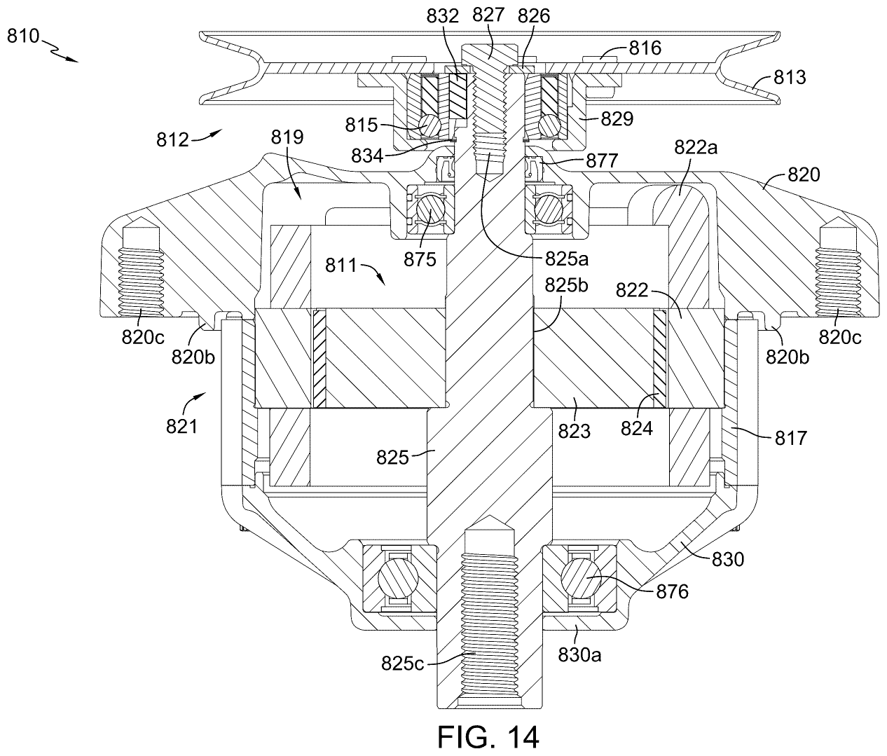

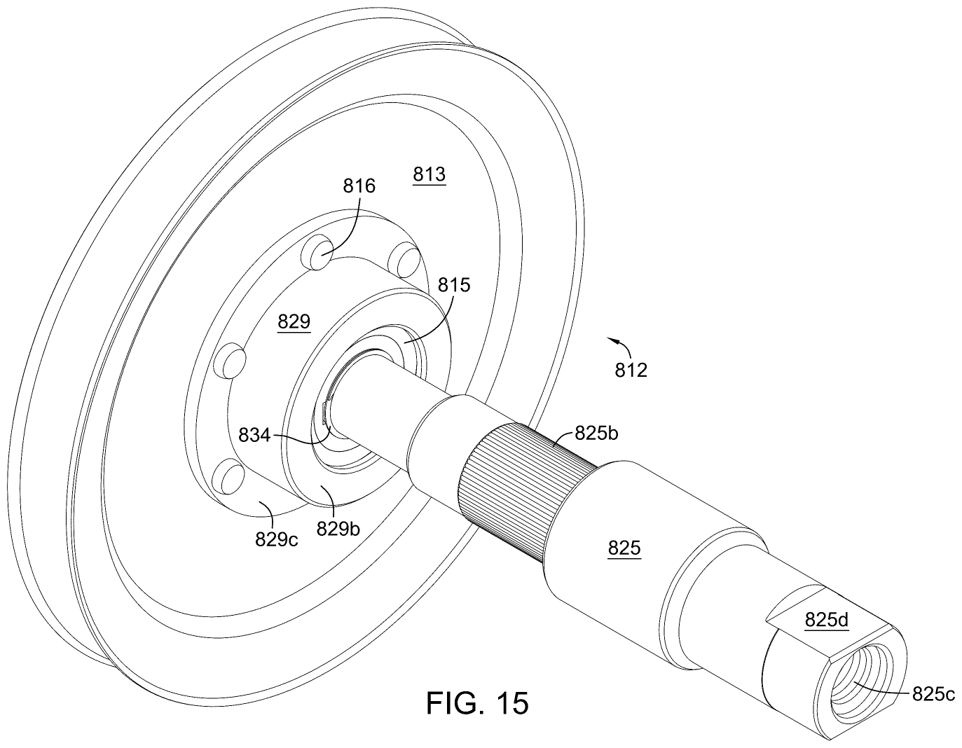

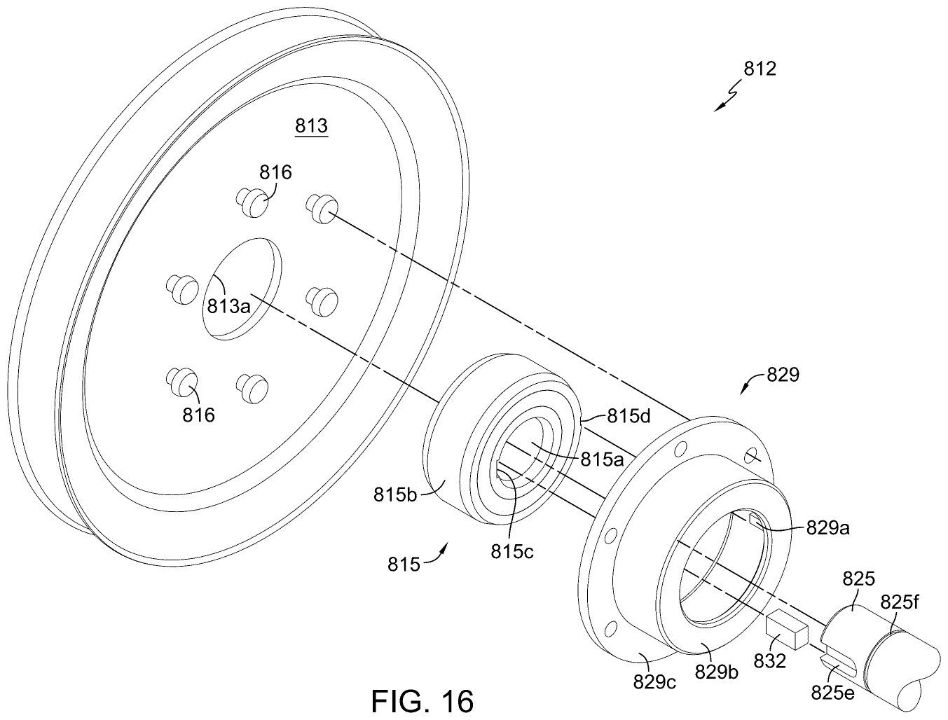

Another embodiment of an electric motor assembly 810 suitable for mounting on the mowing deck 198 of mowing vehicle 190, and enabling the functionality of the parallel hybrid system disclosed herein, is shown in FIGS. 12-14. Motor assembly 810 includes an input pulley assembly 812 comprising pulley 813 and a sealed, one-way clutch bearing 815. The input pulley assembly 812 is mounted on the upper end of electric motor output shaft 825 (see FIG. 15) and retained by a retaining washer 826 and threaded fastener 827 (see FIGS. 13 and 14). Threaded fastener 827 passes through a central hole 813a in pulley 813 (see FIG. 16) to engage an upper threaded bore 825a of output shaft 825. Retaining washer 826 seats against the inner race 815a of one-way clutch bearing 815, such that motor output shaft 825 rotates with inner race 815a. As described more fully below, the one-way clutch 815 is captured within pulley hub 829 which is, in turn, riveted to the pulley 813, such that the pulley 813 rotates with the outer race 815b.

As illustrated, a motor output cap 830 (lower housing) is joined to a motor end cap 820 (upper housing) via fasteners 818, with a motor stator housing 817 (middle housing) interposed between motor output cap 830 and motor end cap 820 to form an electric motor compartment 819 containing electric motor 821. In the exemplary embodiment, motor stator housing 817 is a finned aluminum extrusion cut to a length dependent upon the number of laminations used to form the motor stator (not shown). The fins improve heat dissipation and provide stiffness but may not be required in some similar embodiments. Electric motor 821 comprises a motor stator 822, motor windings 822a (approximate windings envelope shown), and a motor rotor assembly 811 that includes a motor rotor 823 and magnets 824. At the lower end of motor output shaft 825, for attachment of a mower blade 199, adapter mounting features such as lower threaded bore 825c and flats 825d are provided for securing a blade adapter by means of a mechanical fastener and mating flats formed on the blade adapter. Another common blade adapter interface that can be used in lieu of flats 825d is a keyway interface (not shown) that may allow shearing of a “key” in the event a mower blade strikes a solid object. A keyway interface may help prevent or reduce damage to electric deck motor assembly 810 in such an event.

Electric motor output shaft 825 extends through electric motor 821, motor end cap 820 and motor output cap 830. Electric motor output shaft 825 is supported by an upper bearing 875 located in motor end cap 820 adjacent to shaft seal 877 and by a lower sealed bearing 876 located in motor output cap 830. A bearing seal protection flange 830a is formed on motor output cap 830 and configured to fit closely around output shaft 825 to protect the lower sealed bearing 876. Splines 825b formed on motor output shaft 825 permanently secure the motor rotor assembly (not shown) to the motor output shaft 825 via press-fit.

As shown in FIG. 14, motor end cap 820 includes threaded mounting holes 820c to attach electric deck motor 810 to mowing deck 198 of vehicle 190. Pilot features 820b (ridges or protrusions) may be formed on motor end cap 820 as needed to help position each deck motor 810 in a deck motor opening during attachment of deck motor(s) 810 to a deck motor mounting surface of mowing deck 198. The threaded mounting holes 820c are formed on motor end cap 520 to enable mounting of the deck motor(s) 810 from the underside of mowing deck 198 along with attachment of mower blade(s) 199 for efficient assembly. The threaded mounting holes 820c do not penetrate the upper surface of motor end cap 820, thereby protecting the threads of motor mounting fasteners from corrosion and providing a smooth outer surface of motor end cap 820 that is easily cleaned and does not collect water, dirt and debris. Any holes that may be formed in motor end cap 820 (such as assembly aid holes, not shown) may be plugged.

As shown in FIGS. 12 and 13, an environmentally sealed electrical connector 814 is attached or mounted to an electrical compartment cover 873. Compartment cover 873 includes connector guards 873a that extend beyond the sealed electrical connector 814 to protect it. Compartment cover 873 is secured by fasteners 874 to an electrical compartment 820a that may be integrally formed on the motor end cap 820.

As an option, a Hall effect board (not shown) may be attached to motor end cap 820 adjacent to the rotor assembly as illustrated and described in more detail in commonly-owned U.S. Pat. No. 11,211,844, which is incorporated by reference herein in its entirety. When configured with such a Hall effect board, electric motor assembly 810 can provide motor operational information (e.g., motor speed and temperature) to one or more electronic components of the vehicle control system.

Input pulley assembly 812 is depicted in FIGS. 15 and 16. Input pulley assembly 812 includes a pulley hub 829 that houses the one-way clutch bearing 815. Similar to one-way clutch bearing 515, this bearing is also known as a “sprag clutch” or “sprag clutch bearing.” Bearing 815 comprises a bearing inner race 815a with inner keyway 815c and a bearing outer race 815b with outer keyway 815d. A mounting flange 829c of pulley hub 829 is attached to pulley 813 by means of rivets 816 (shown upset/formed and in their installed location in both FIGS. 15 and 16), but could also be attached with other types of fasteners such as screws into threaded housings or bolts through unthreaded housings. A bearing outer race retention flange 829b of pulley hub 829 helps retain the bearing outer race 815b, and a hub key 829a of pulley hub 829 engages the outer bearing race keyway 815d such that pulley 813 rotates with the bearing outer race 815b. A key 832 engages the inner bearing race keyway 815c and the output shaft keyseat 825e of output shaft 825 such that the electric motor output shaft 825 rotates with the bearing inner race 815a. During assembly, bearing 815 is slipped onto the upper end of the motor output shaft 825 to seat against a retaining ring 834 installed in retaining ring groove 825f. Bearing 815 is retained along with the other components of input pulley assembly 812 when retaining washer 826 and fastener 827 are installed through the central hole 813a in pulley 813 and into threaded bore 825a of motor output shaft 825 as illustrated in FIG. 14. A shoulder similar to shoulder 525e shown in FIG. 7 may be formed on output shaft 825 in lieu of using retaining ring 834 illustrated in this embodiment.

As illustrated, electric motor assembly 810 does not utilize a bearing adapter such as bearing adapter 528 of FIG. 7. The inner diameter of inner race 815a of clutch bearing 815 is smaller than the inner diameter of inner race 515a of bearing 515 to the extent that such an adapter is not required. Optimal bearing size and associated output shaft interface diameter may differ based on desired bearing life and torque loads.

The motor output shaft 825 rotates independently when driven by electric power only and rotates with pulley 813 when pulley 813 is driven at sufficient speed by the IC engine that the pulley's RPM (outer race 815b) reaches (and matches) that of the output shaft (inner race 815a), causing the clutch function of the one-way clutch bearing 815 to engage. This causes the inner race and outer race to rotate together such that the input pulley assembly 812 drives the motor output shaft 825. With rotational speeds of pulley 813 and motor output shaft 825 matched, the connector (or other conductor) sends power to the battery when the belt power to pulley 813 exceeds the load on the motor output shaft 825 (transferred from a deck motor blade 199, for example).

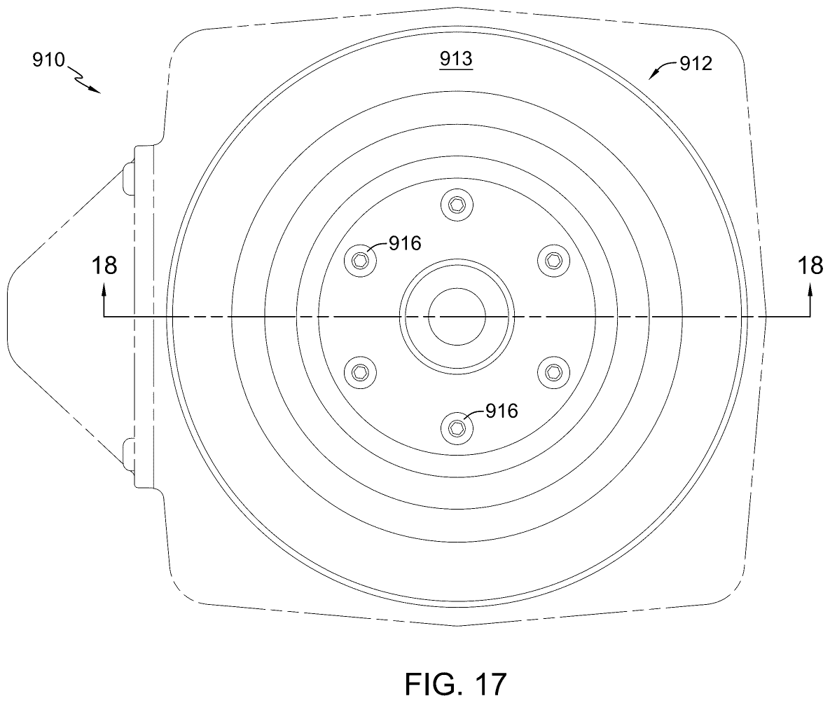

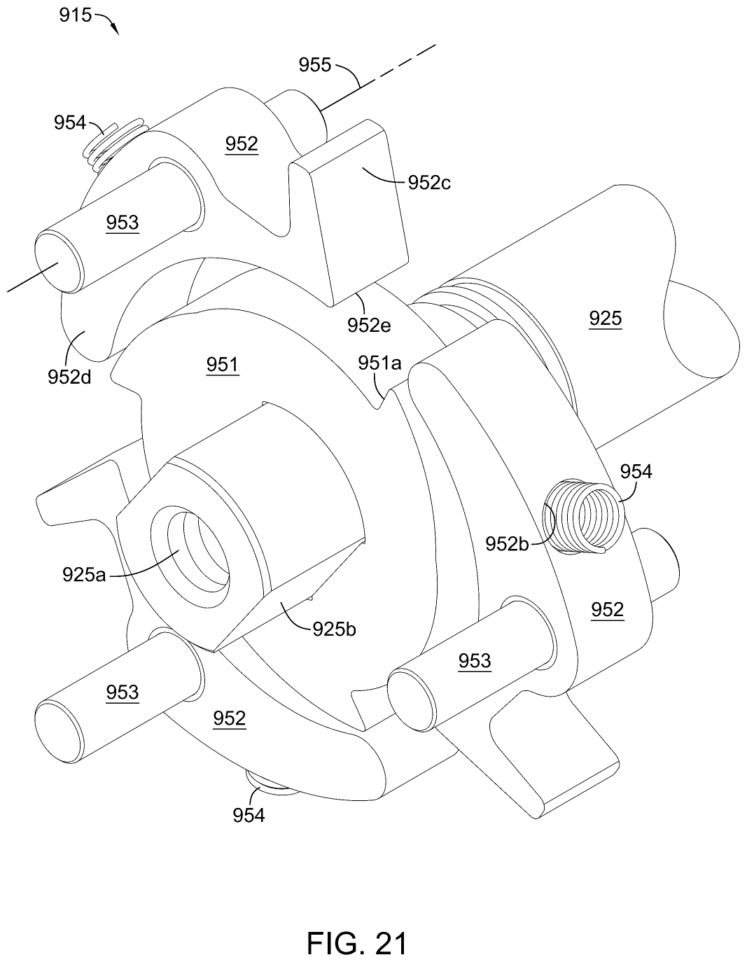

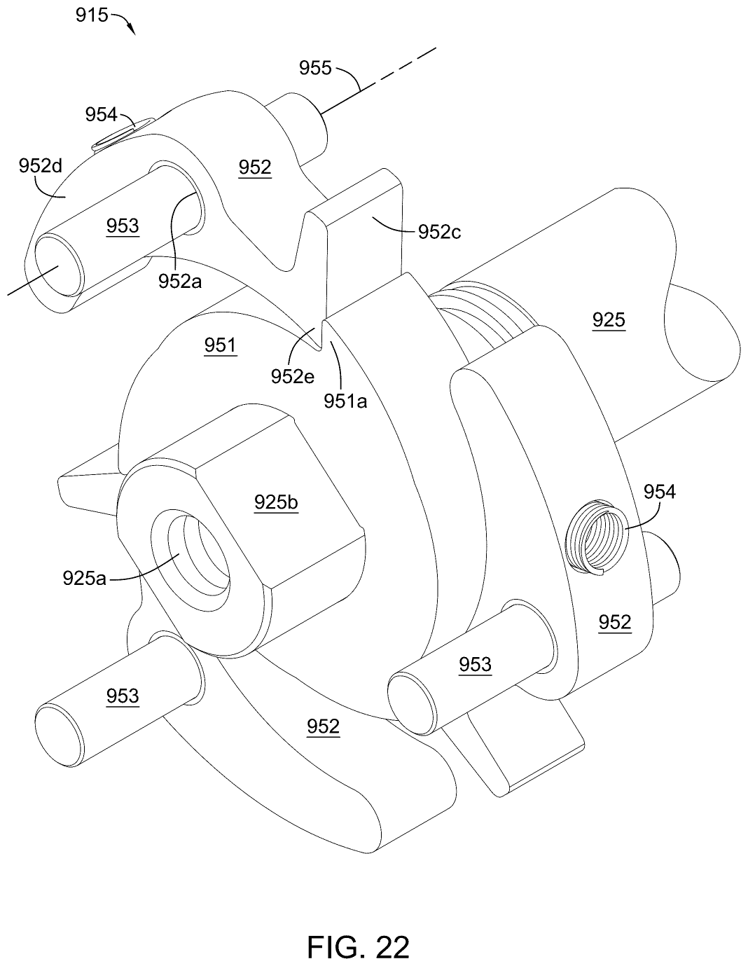

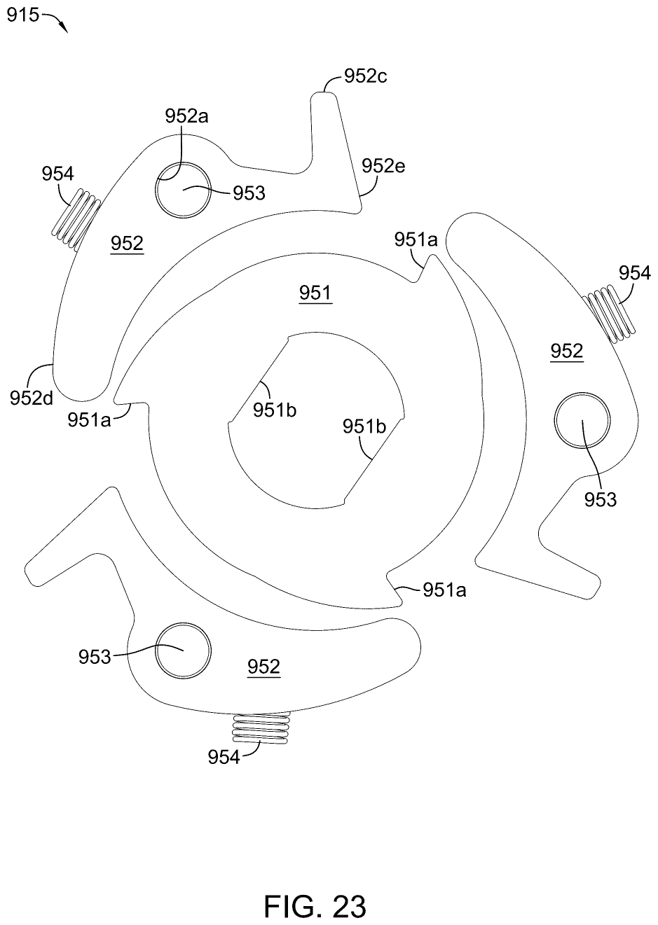

Another embodiment of an electric motor assembly 910 suitable for mounting on the mowing deck 198 of mowing vehicle 190, and enabling the functionality of the parallel hybrid system disclosed herein, is shown in FIGS. 17-23. Motor assembly 910 includes an input pulley assembly 912 comprising a pulley 913 and a pulley hub assembly 929. Other than input pulley assembly 912 and modification of the motor output shaft to accommodate mounting of pulley hub assembly 929, motor assembly 910 may be the same as the previously described motor assembly 810. The pulley hub assembly 929 includes a one-way clutch mechanism 915 that, similar to the sprag clutch bearings 515, 815, is a one-way torque transmitting device.

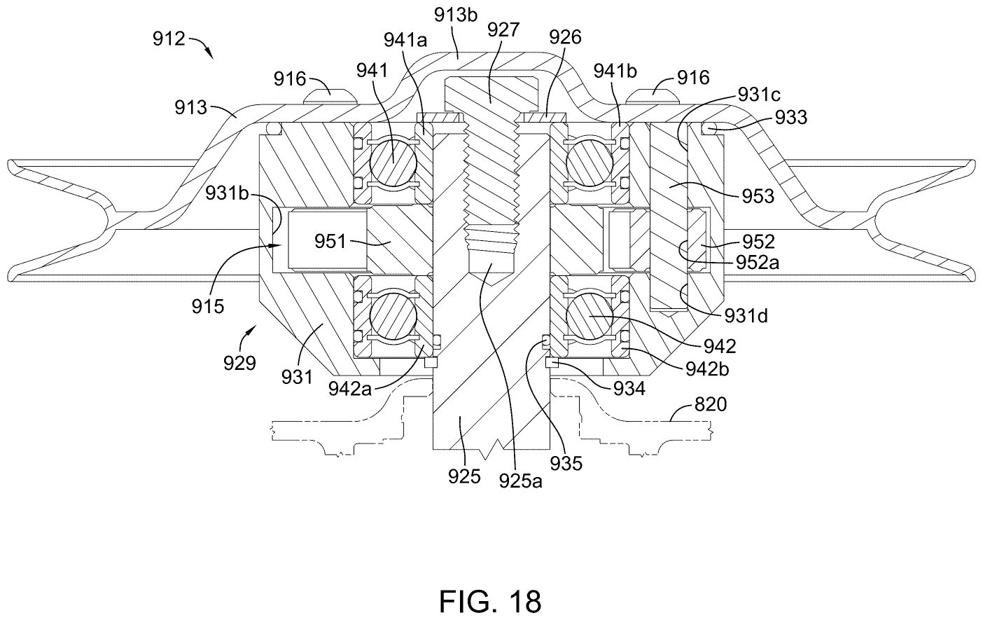

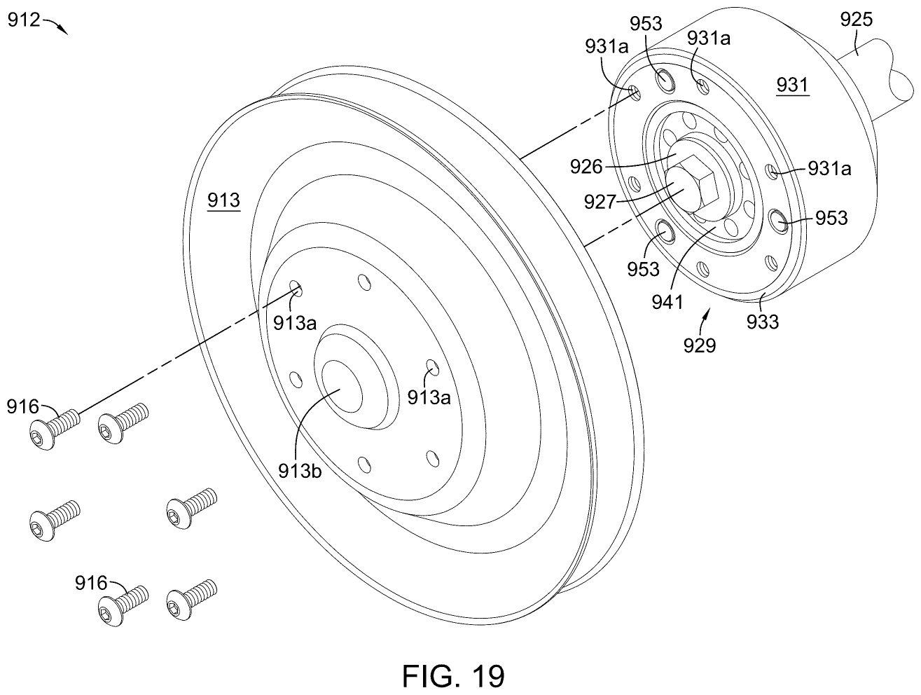

The pulley hub assembly 929 includes a pawl carrier (or hub housing) 931 containing an upper hub bearing 941 and a lower hub bearing 942, with a one-way clutch mechanism 915 sandwiched between the pair of sealed bearings 941, 942. Pulley hub assembly 929 is mounted on the upper end of electric motor output shaft 925 and is retained by a retaining washer 926 and threaded fastener 927 (see FIGS. 18 and 19). Threaded fastener 927 engages an upper threaded bore 925a of motor output shaft 925. Retaining washer 926 seats against the inner race 941a of upper hub bearing 941, and motor output shaft 925 rotates with inner race 941a and with inner race 942a of lower hub bearing 942. Inner race 942a seats against retaining ring 934 or, alternatively, against a shoulder formed on motor output shaft 925 similar to shoulder 525e shown in FIG. 7.

Pulley 913 is attached to the hub housing 931 by means of threaded fasteners 916 that extend through a plurality of holes 913a formed in pulley 913 to engage a plurality of threaded holes or bores 931a formed in hub housing 931, so pulley 913 rotates with the outer race 941b of upper hub bearing 941 and outer race 942b of lower hub bearing 942. Rather than having a central hole such as central hole 813a of pulley 813, pulley 913 includes a central dome 913b that protects and conceals pulley mounting fastener 927 and pulley hub assembly 929. The pulleys illustrated herein may include either a central hole or a central dome structure.

An upper O-ring 933 seals the upper perimeter of hub housing 931 and a lower O-ring 935 positioned near retaining ring 934 seals the interface between inner race 942a and motor output shaft 925. The combination of the domed pulley structure, the pair of sealed bearings, and upper and lower O-rings protects the input pulley assembly 912 from environmental contamination and damage. Grease or other lubrication may be used to further protect and extend the service life of the one-way clutch mechanism 915.

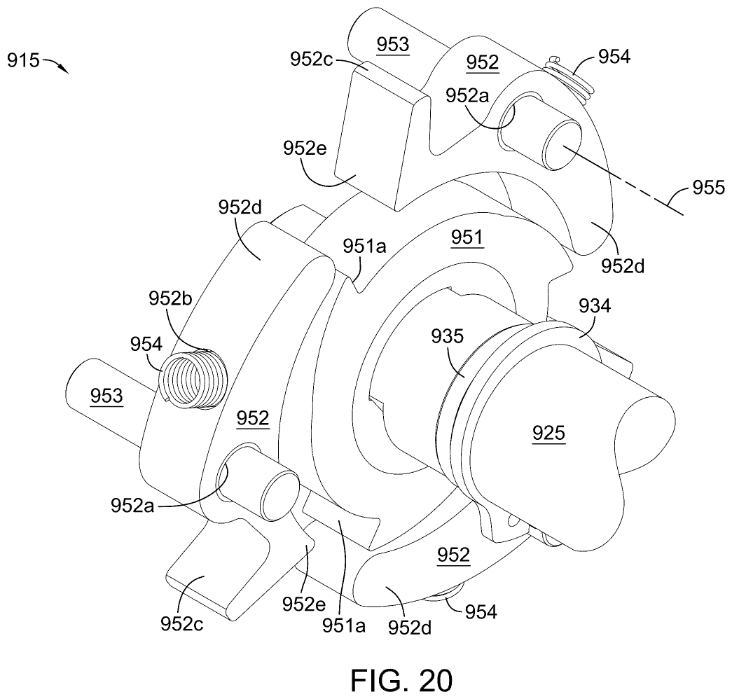

Hub housing 931 (a.k.a. pawl carrier 931) serves as a pawl carrier for the one-way clutch mechanism 915. The one-way clutch mechanism 915, comprising a ratchet and a plurality of pawls, is illustrated in FIGS. 20-23. Ratchet 951 is flanked by the upper and lower bearings 941, 942, includes a plurality of ratchet teeth 951a, and is installed on the upper end of the motor output shaft 925. Internal flats 951b formed on ratchet 951 interface with external upper flats 925b formed on the upper end of motor output shaft 925 so the ratchet 951 rotates with motor output shaft 925.

As shown in FIGS. 18-20, Each pawl 952 is pivotably mounted on a pivot pin 953 (also referred to as a “pawl pivot pin”) installed in pawl carrier 931 so the pawls 952 rotate with pawl carrier 931 (and thereby with pulley 913). Pawls 952 are disposed in an internal cylindrical groove 931b formed in pawl carrier 931. As assembled, each pivot pin 953 extends through an upper hole 931c formed in pawl carrier 931, through a pivot pin hole 952a formed in each pawl 952 and into a lower bore 931d formed in pawl carrier 931. Each pawl 952 is biased to a disengaged position by a spring 954 installed in a bore 952b formed in pawl 952. A travel limit arm 952c of each pawl 952 extends in a first direction from pivot pin hole 952a/pivot pin 953/pawl pivot axis 955 and bears against the cylindrical surface of the cylindrical groove 931b when clutch mechanism 915 is in a clutch-disengaged mode. Each travel limit arm 952c comprises a pawl catch 952e that contacts/engages a ratchet tooth 951a as clutch mechanism 915 enters a clutch-engaged mode. A counterweight arm 952d extends arcuately in a substantially opposite second direction from pivot pin hole 952a/pivot pin 953/pawl pivot axis 955.

When vehicle 190 is operating solely under electric power, IC engine 191 is off and the one-way clutch mechanism 915 is disengaged. In this case, pulley(s) 913 are at rest and the rotational speed of pawl carrier 931 is zero. Clutch mechanism 915 engagement occurs when IC engine 191 runs and drives the pulley(s) 913 (along with pawl carrier 931) at a rotational speed that causes each counterweight arm 952d of each pawl 952 to pivot outward while each pawl catch 952e of each pawl 952 pivots inward to contact/engage a ratchet tooth 951.

The rotational speed of the pawl carrier, the location of the pawl center of mass relative to its pivot axis and the spring force of the biasing spring affect the pivoting motion of the pawls. The engineered location or “setting” of the center of mass of the pawl, along with the spring rate and spring preload of the biasing spring, determines the pawl carrier rotational speed at which the pawls pivot to engage and disengage with the ratchet. The location of the pawl center of mass relative to the pawl pivot axis determines whether the pawl is engaged above or below a target rotational speed of the pawl carrier.

The ratchet 951 of one-way clutch mechanism 915 is joined to and rotates with the motor output shaft 925 at a first rotational speed. The pulley 913, along with pulley hub assembly 929 comprising pawl carrier (hub housing) 931 and pawls 952, rotates at a predetermined second rotational speed, causing the pawls 952 to contact the ratchet 951. (That is, IC engine 191 starts and catches up with the speed of deck motor(s) 910.) If the pawls 952 are contacting the ratchet 951 and the second rotational speed matches the first rotational speed, the motor output shaft 925 is then driven by the combustion power source (e.g., internal combustion engine 191).

The amount of pawl ratcheting depends on the clutch engagement speed relative to the usual deck motor speed. If the two speeds are close there will be only a small amount of ratcheting while the engine cycles on and off.

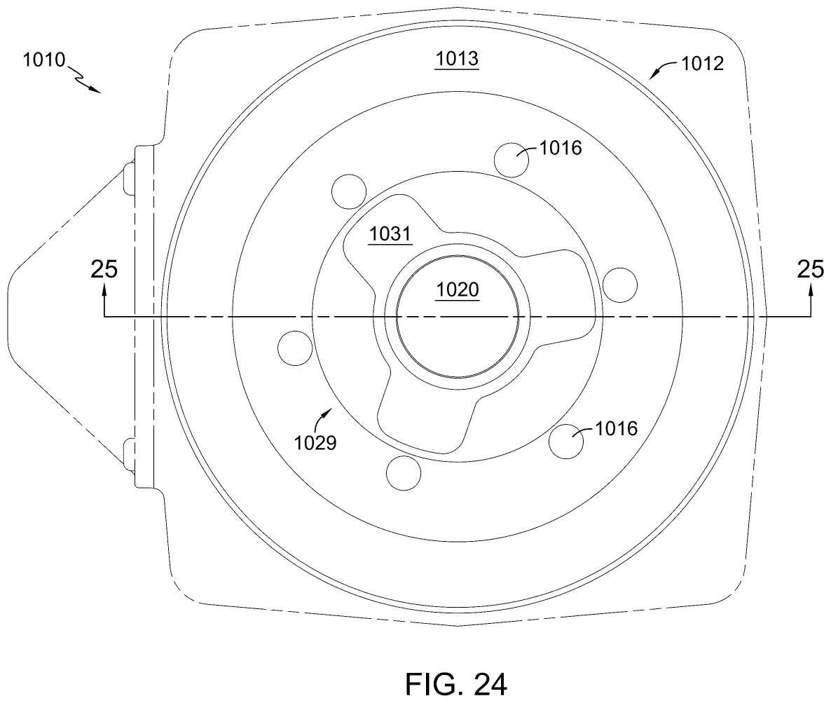

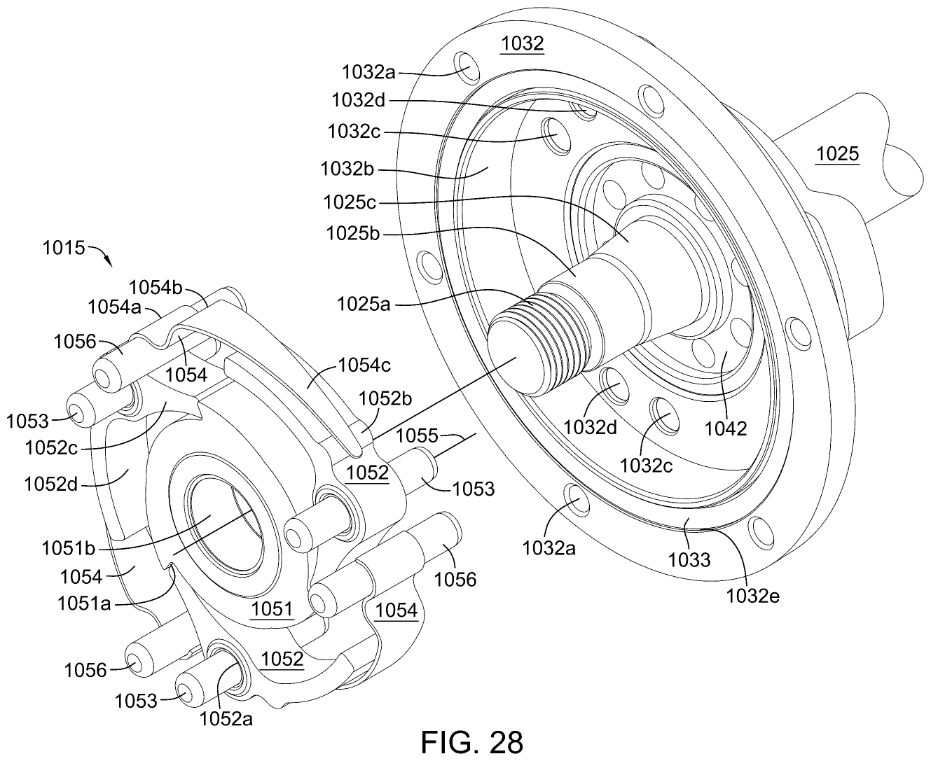

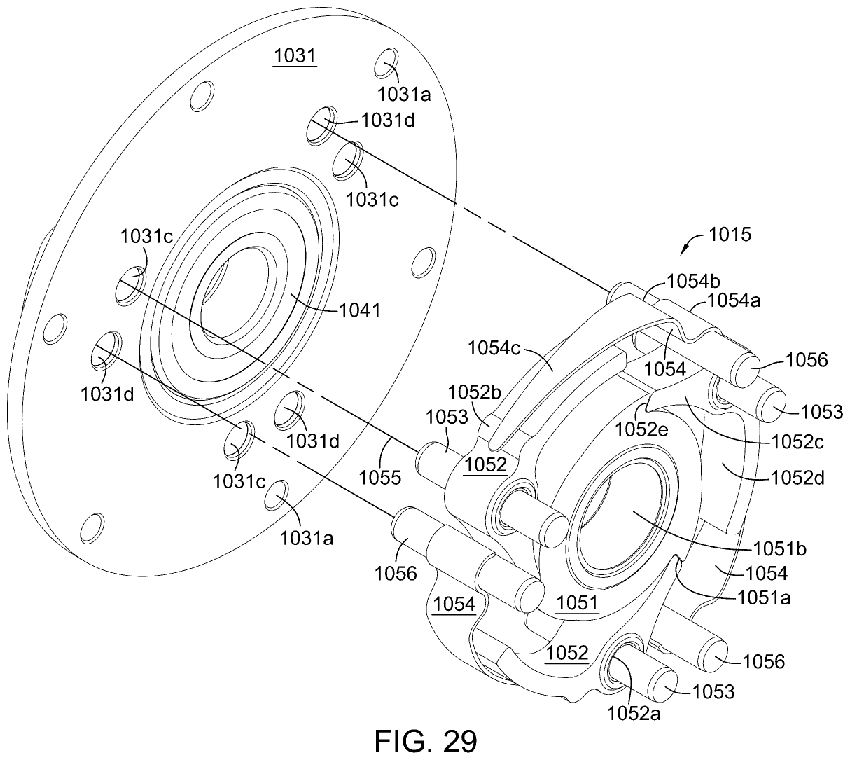

A further embodiment of an electric motor assembly 1010 suitable for mounting on the mowing deck 198 of mowing vehicle 190, and enabling the functionality of the parallel hybrid system disclosed herein, is shown in FIGS. 24-31. Motor assembly 1010 includes an input pulley assembly 1012 comprising a pair of pulleys 1013, 1014 and a pulley hub assembly 1029 disposed therebetween. As described below, pulley hub assembly 1029 includes a one-way clutch mechanism 1015 having a pawl and ratchet mechanism that varies in form from that of pulley hub assembly 929, as does the manner of its engagement to motor output shaft 1025. Electric motor assembly 1010 may be the same as the previously described motor assemblies 810, 910.

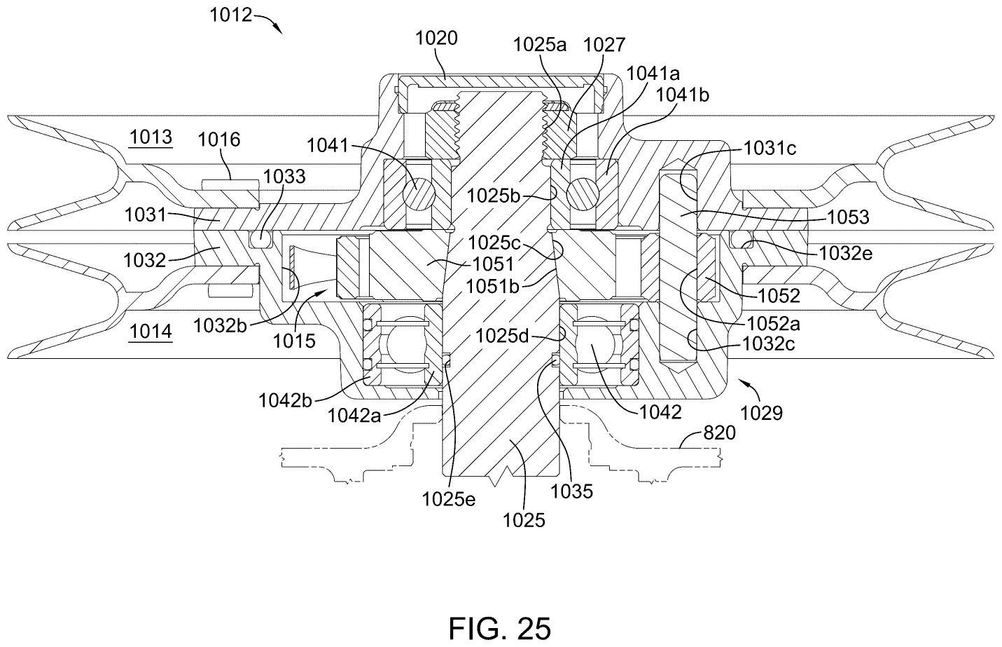

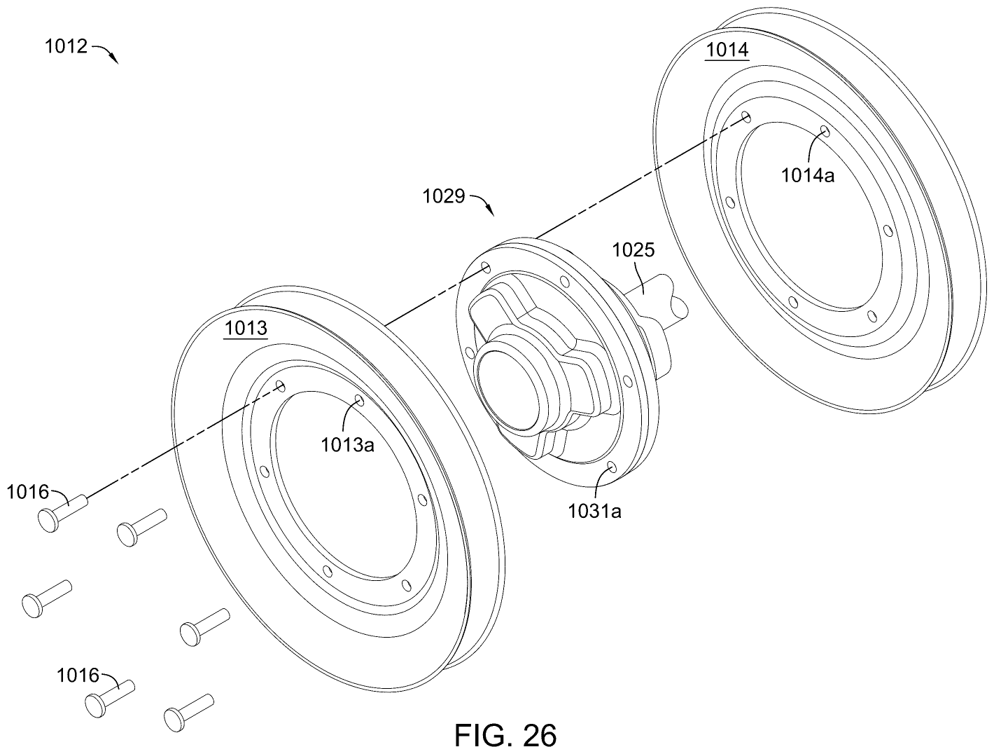

Pulley hub assembly 1029 includes a sealed hub housing having a lower hub housing 1032 and an upper hub housing 1031, which are joined together to form a pawl carrier of one-way clutch mechanism 1015. Lower hub housing 1032 is configured to contain other components of one-way clutch mechanism 1015 in an internal cylindrical compartment 1032b. Pulley hub assembly 1029 is sealed by upper O-ring 1033 in O-ring groove 1032e. As shown in FIGS. 25 and 26, pulley hub assembly 1029 may serve to support a pair of pulleys 1013, 1014 from opposite sides of its housing. For example, a second pulley, such as pulley 1014, is useful to belt drive an auxiliary mechanism, such as a fan or blower on a mowing vehicle's bagger system. A plurality of fasteners 1016, illustrated here as solid rivets that join the components of input pulley assembly 1012, are fed through circumferentially aligned pulley attachment holes 1013a, pulley attachment bores 1031a, pulley attachment bores 1032a, and pulley attachment holes 1014a, respectively, prior to having their tails deformed. Lower hub housing 1032 and upper hub housing 1031 are joined together by this process. It will be understood that input pulley assembly 1012 may be configured in various arrangements of one or two pulleys, and fasteners 1016 may take the form of bolts and nuts or other suitable fasteners.

As best shown in FIG. 25, input pulley assembly 1012 is configured to mount to the upper end of motor output shaft 1025, external to motor endcap 820. Specifically, a sealed lower hub bearing 1042 is pressed into a pocket of lower hub housing 1032 and has an outer race 1042b that permits pulleys 1013, 1014 to be belt driven by a combustion power source, such as internal combustion engine 191 of mowing vehicle 190. Lower hub bearing 1042 also has an inner race 1042a that engages motor output shaft 1025 at lower bearing land 1025d to permit motor output shaft 1025 to rotate independent of pulleys 1013, 1014 when electric motor assembly 1010 is only driven by an electrical power source, such as high voltage battery 175 of mowing vehicle 190. A lower O-ring 1035 is disposed in motor output shaft groove 1025e of motor output shaft 1025 and between motor output shaft 1025 and inner race 1042a to seal the bottom of pulley hub assembly 1029.

A sealed upper hub bearing 1041 is pressed into a pocket of upper hub housing 1031 and has an outer race 1041b that permits pulleys 1013, 1014 to be belt driven by a combustion power source. Upper hub bearing 1041 also has an inner race 1041a that engages motor output shaft 1025 at upper bearing land 1025b to permit motor output shaft 1025 to rotate independently of pulleys 1013, 1014 when electric motor assembly 1010 is only driven by an electrical power source. Motor output shaft 1025 differs in profile from that of motor output shafts 825 and 925 in that it features a tapered shaft with an externally threaded upper end 1025a. The diameter of motor output shaft 1025 tapers across tapered ratchet interface 1025c between lower bearing land 1025d and upper bearing land 1025b. Accordingly, the ratchet 1051 of one-way clutch mechanism 1015, which is located between upper hub bearing 1041 and lower hub bearing 1042, has a centralized tapered bore 1051b configured to engage tapered ratchet interface 1025c. Based on the above described structure, input pulley assembly 1012 is able to be slipped onto motor output shaft 1025 as a single unit; secured there by a mounting fastener, such as threaded locknut 1027; and tightened down on threaded upper end 1025a. When threaded locknut 1027 is properly torqued, the tapered interface creates a strong connection between input pulley assembly 1012 and motor output shaft 1025. The tapered interface has the further advantages of preventing misassembly and allowing a slip point during extreme torque impacts, such as when a mower blade 199 fastened to the lower end of motor output shaft 1025 encounters an immovable object. A plug seal 1020 inserted into the hub attachment access opening 1031b of upper hub housing 1031 completes the environmental protection of pulley hub assembly 1029.

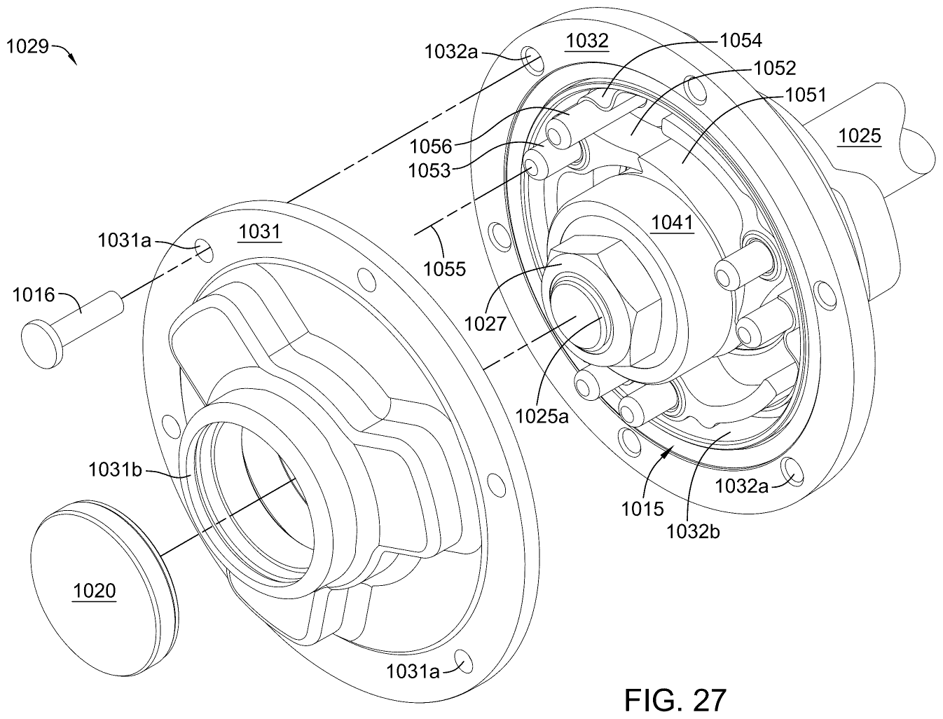

The structure and function of the one-way clutch mechanism 1015 of pulley hub assembly 1029 is detailed in FIGS. 27-31. A plurality of pivot pins 1053 (also referred to as “pawl pivot pins”) are located in symmetrically distributed pivot pin lower bores 1032c at the bottom of internal cylindrical compartment 1032b. Pivot pins 1053 may be press fit into the pivot pin lower bores 1032c. A plurality of spring retention pins 1056 are similarly located in symmetrically distributed spring retention pin lower bores 1032d adjacent the pivot pin lower bores 1032c. As with the pivot pins 1053, spring retention pins 1056 may be press fit into spring retention pin lower bores 1032c.

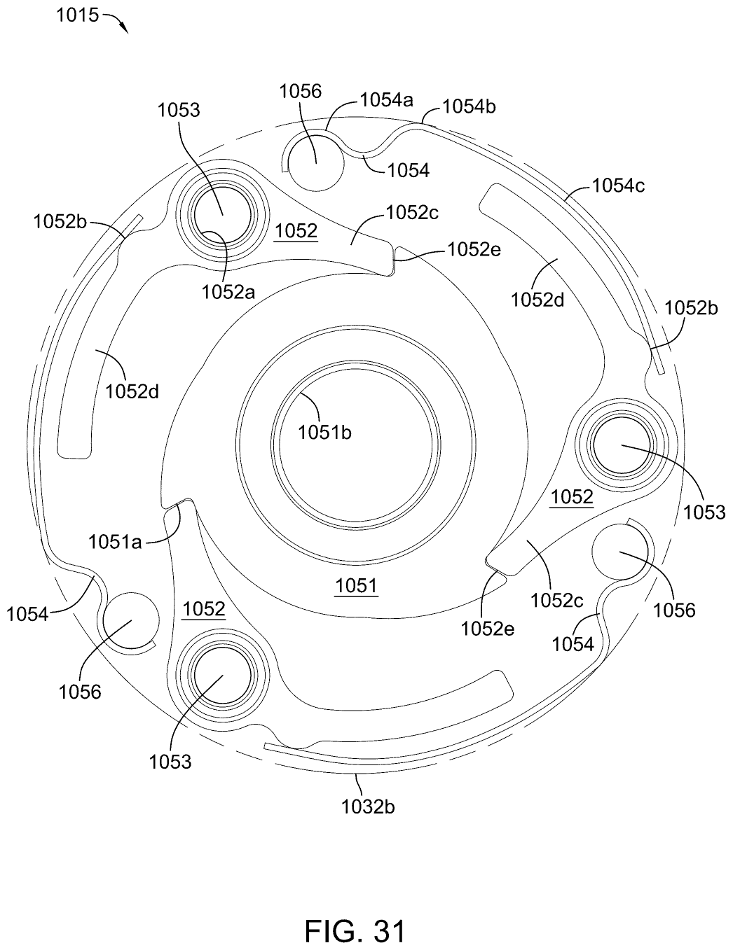

A plurality of pawls 1052 each have a pivot pin through-hole 1052a, a ratchet engagement arm 1052c, and a counterweight arm 1052d. Each pawl 1052 is pivotably mounted on a respective pivot pin 1053 and is configured to pivot freely thereabout along a respective pawl pivot axis 1055. Each pawl 1052 is oriented such that a pawl catch 1052e at a distal end of its ratchet engagement arm 1052c and a respective one of the ratchet teeth 1051a of ratchet 1051 will come into direct engagement when pulleys 1013, 1014 overdrive motor output shaft 1025 as shown in FIG. 31. Each pawl 1052 also is biased to a disengaged position by a respective spring 1054.

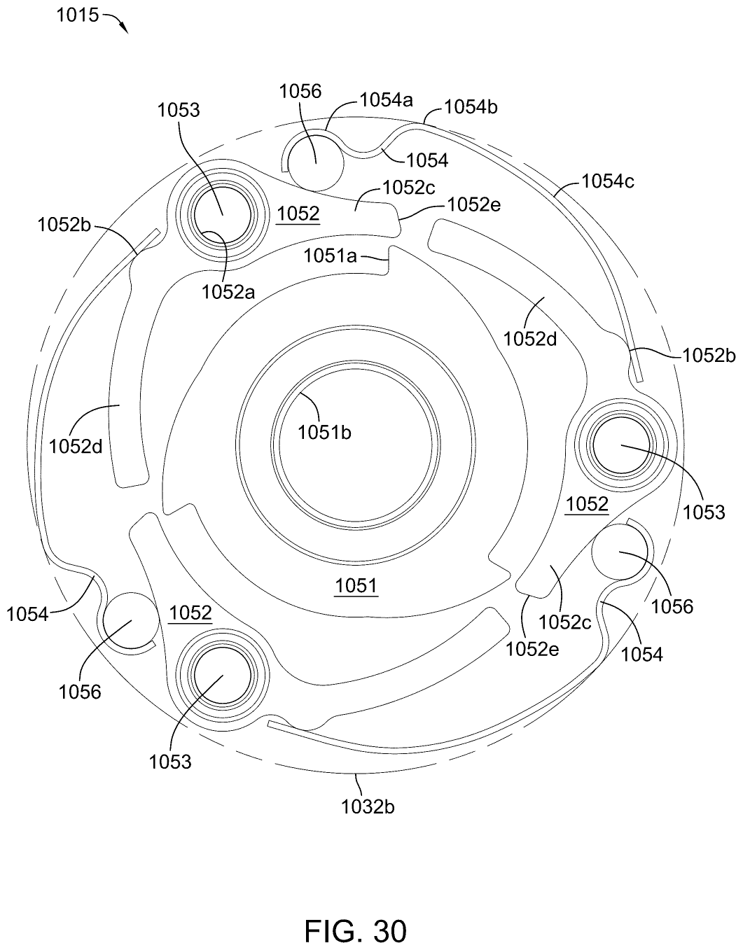

In the illustrated example, each spring 1054 is a leaf spring 1054 that is captured between a respective spring retention pin 1056 and the wall of internal cylindrical compartment 1032b. Each spring 1054 has a pin engagement curve 1054a that hooks onto the spring retention pin 1056, a housing engagement portion 1054b that contacts the wall of internal cylindrical compartment 1032b, and a flex portion 1054c that is brought into engagement with the contact surface 1052b of pawl 1052. In the illustrated example, pin engagement curve 1054a is at a proximal end of spring 1054, housing engagement portion 1054b is curved and at an intermediate portion of spring 1054, and flex portion 1054c is curved and at a distal end of spring 1054. It will be understood that springs 1054 bias the pawls 1052 of one-way clutch mechanism 1015 into a disengaged state as shown in FIG. 30. The springs 1054 of the illustrated example are durable and are relatively easy to install and retain with their pin engagement curves 1054a. Further, grease or other lubrication may be used to protect elements of one-way clutch 1015 from corrosion, to ensure freedom of movement for pawls 1052 about pivot pins 1053, and to extend service life. Lubricating the pawls 1052 also serves to damp their movement during engagement and disengagement with the ratchet 1051.

Upper hub housing 1031 has a corresponding set of symmetrically distributed pivot pin upper bores 1031c and spring retention pin upper bores 1031d to receive the free end of each of the plurality pivot pins 1053 and spring retention pins 1056 when upper hub housing 1031 and lower hub housing 1032 are joined together.

As illustrated, three sets of pawls 1052 and springs 1054 may be utilized in one-way clutch mechanism 1015 with a ratchet 1051 having three ratchet teeth 1051a. In other examples, a different number of sets may be symmetrically oriented in internal cylindrical compartment 1032b with a ratchet 1051 having the corresponding number of ratchet teeth 1051a.

The function of one-way clutch mechanism 1015 is essentially as described for one-way clutch mechanism 915. Ratchet 1051 rotates with motor output shaft 1025 at a first rotational speed when electric motor assembly 1010 operates in EV Mode, Hybrid Mode, or Power Mode. When the combustion power source, such as internal combustion engine 191, is commanded by VIM 107 to start (whether in Hybrid Mode or Power Mode), belt-driven pulleys 1013, 1014 begin to rotate the joined upper hub housing 1031 and lower hub housing 1032 that serve as a pawl carrier. As the speed of rotation of the pawl carrier ramps up, the biasing effect of springs 1054 contacting each pawl 1052 at spring contact surface 1052b forces engagement of ratchet engagement arm 1052c against spring retention pin 1056 to prevent chatter and unwanted noise from one-way clutch mechanism 1015 during operation. As the rotational speed of the pawl carrier increases, the centrifugal forces (radial and tangential) acting on pawl counterweight arm 1052d eventually overcome the biasing force of spring 1054 to pivot pawl 1052 about pivot pin 1053 and bring it into rotational engagement with ratchet 1051 to drive motor output shaft 1025. The mass of the pawl 1052, its distribution between ratchet engagement arm 1052c and counterweight arm 1052d, and the spring strength of spring 1054 can be configured such that pivoting of the pawls 1052 about pivot pins 1053 occurs at or near a particular rotational speed of the pawl carrier. Ideally, this rotational speed of the pawl carrier is just below (perhaps 50 RPM less than) a target rotational speed of the motor output shaft, such that clutch engagement occurs just as the ratchet/output shaft rotational speed falls below this target. For example, when electric motor assembly 1010 serves as a mowing deck motor, a target rotational speed of motor output shaft 1025 may be 3400 rpm to ensure cut quality. Adjustment of the pawl mass distribution and spring strength permit clutch engagement at other rotational speeds depending upon application.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof. Prior to examination, please amend the claims as follows:

1. A hybrid power system for a utility vehicle, comprising:
an electric motor including an output shaft and a conductor configured to alternatively receive power from or send power to an electrical power source;
an internal combustion engine;
a first pulley connected to and rotated by the internal combustion engine;
a clutch mechanism comprising:
a ratchet connected to the output shaft of the electric motor to rotate at a first rotational speed;
a pawl carrier driven by the internal combustion engine to rotate at a second rotational speed; and
one or more pawls coupled to and configured to rotate with the pawl carrier, wherein the one or more pawls are configured to be disengaged from the ratchet in a disengaged state during which the first rotational speed of the ratchet is different than the second rotational speed of the pawl carrier.

2. The hybrid power system of claim 1, further comprising a second pulley configured to drive an auxiliary mechanism of the utility vehicle, and wherein the clutch mechanism is disposed between the first pulley and the second pulley.

3. The hybrid power system of claim 1, wherein the clutch mechanism further comprises one or more leaf springs, wherein each leaf spring is configured to bias a respective pawl to be disengaged from the ratchet such that the ratchet is able to rotate at a first rotational speed that is different than a second rotational speed of the pawl carrier in a disengaged state.

4. The hybrid power system of claim 3, wherein the clutch mechanism further comprises one or more spring retention pins, wherein each leaf spring is secured between a respective spring retention pin and an internal wall of the pawl carrier.

5. The hybrid power system of claim 4, wherein each pawl includes a ratchet engagement arm that is configured to:
contact an adjacent spring retention pin in the disengaged state to deter chatter; and
engage a respective tooth of the ratchet in an engaged state.

6. The hybrid power system of claim 1, wherein the clutch mechanism further comprises one or more pivot pins, wherein each pawl is coupled and configured to pivot about a respective pivot pin.

7. The hybrid power system of claim 1, wherein the ratchet is configured to rotate with the output shaft of the electric motor at the first rotational speed in an electric vehicle (EV) mode, a hybrid mode, or a power mode.

8. The hybrid power system of claim 7, wherein the pawl carrier is configured to be driven by the internal combustion engine to rotate at the second rotational speed in the hybrid mode or the power mode.

9. A clutch mechanism for a hybrid power system of a utility vehicle, comprising:
a ratchet connected to an output shaft of an electric motor;
a pawl carrier driven by an internal combustion engine;
one or more pawls coupled to and configured to rotate with the pawl carrier; and
one or more leaf springs, wherein each leaf spring is configured to bias a respective pawl to be disengaged from the ratchet such that the ratchet is able to rotate at a first rotational speed that is different than a second rotational speed of the pawl carrier in a disengaged state.

10. The clutch mechanism of claim 9, wherein the second rotational speed is less than the first rotational speed in the disengaged state, and the second rotational speed equals the first rotational speed of the ratchet in an engaged state.

11. The clutch mechanism of claim 10, wherein a biasing force of the leaf spring is configured to be overcome by centrifugal forces acting on the one or more pawls such that the pawls pivot into an engaged position at a second rotational speed slightly less than a target rotational speed of the motor output shaft.

12. The clutch mechanism of claim 9, further comprising one or more pivot pins, wherein each pawl is configured to pivot about and couple to the pawl carrier via a respective pivot pin

13. The clutch mechanism of claim 9, wherein each pawl includes:
a through-hole to receive a respective pivot pin about which the pawl is configured to pivot;
a ratchet engagement arm extending away from the through-hole configured to engage a respective tooth of the ratchet in an engaged state; and
a counterweight arm extending away from the through-hole in a direction opposite to that of the ratchet engagement arm.

14. The clutch mechanism of claim 13, wherein the counterweight arm of each pawl defines a spring contact surface at which a respective leaf spring contacts the pawl for biasing toward the disengaged state.

15. The clutch mechanism of claim 13, wherein a pawl catch at a distal end of the ratchet engagement arm is configured to engage the respective tooth of the ratchet in the engaged state.

16. The clutch mechanism of claim 13, wherein a mass of each pawl, a mass distribution between the ratchet engagement arm and the counterweight arm of each pawl, and a spring strength of each leaf spring enable centrifugal forces to overcome a biasing force of the leaf spring such that the pawls pivot into an engaged position at a second rotational speed slightly less than a target rotational speed of the motor output shaft.

17. The clutch mechanism of claim 13, wherein the ratchet engagement arm is configured to contact an adjacent spring retention pin in the disengaged state to deter chatter.

18. The clutch mechanism of claim 9, further comprising one or more spring retention pins, wherein each leaf spring is secured between a respective spring retention pin and an internal wall of the pawl carrier.

19. The clutch mechanism of claim 18, wherein each leaf spring includes:
a pin engagement curve that hooks onto a respective spring retention pin;
a housing engagement portion that contacts the internal wall; and
a flex portion that engages a respective pawl.

20. The clutch mechanism of claim 19, wherein each leaf spring includes:
a proximal end at which the pin engagement curve is located;
an intermediate portion at which the housing engagement portion is located; and
a distal end at which the flex portion is located.
